(19) United States
(12) Patent Application Publication
(10) Pub. No.: US 2024/0314308 A1
(43) Pub. Date: Sep. 19, 2024

(54) VIDEO CODING APPARATUS AND DECODING APPARATUS

(71) Applicant: Sharp Kabushiki Kaisha, Sakai City, Osaka (JP)

(72) Inventors: Takuya SUZUKI, Sakai City (JP); Eiichi SASAKI, Sakai City (JP); Takeshi CHUJOH, Sakai City (JP); Tomohiro IKAI, Sakai City (JP); Norio ITOH, Sakai City (JP); Hiroshi WATANABE, Tokyo (JP)

(21) Appl. No.: 18/279,783

(22) PCT Filed: Mar. 4, 2022
(86) PCT No.: PCT/JP2022/009378

§ 371 Date: Aug. 31, 2023

(30) Foreign Application Priority Data
Mar. 11, 2021 (JP) 2021-039720

(51) Int. Cl. H04N 19/117; G06V 10/82; H04N 19/46; H04N 19/59; H04N 19/82

(52) U.S. Cl. CPC H04N 19/117; G06V 10/82; H04N 19/46; H04N 19/59; H04N 19/82

(57) ABSTRACT

In a case that a model parameter suitable for an input video is selected from a set of prescribed model parameters and that resolution inverse conversion to be applied is performed, a video unsuitable for multiple model parameters may have lower quality. Included are an image decoding apparatus configured to decode coded data obtained by coding an image subjected to resolution conversion and filter information for deriving a first model parameter and a post-processing apparatus configured to perform conversion into the same resolution as an input image signal by using the image and the filter information decoded by the image decoding apparatus. Included are a composite information creating apparatus configured to create filter information for deriving the first model parameter and an image coding apparatus configured to code the image pre-processed in the resolution conversion or the like, and the filter information created by the composite information creating apparatus.

### CROSS-REFERENCE OF RELATED APPLICATION

The present application claims priority of JP 2021-039720, filed on Mar. 11, 2021, and all the contents thereof are included herein by the reference.

### TECHNICAL FIELD

Embodiments of the present invention relate to a video coding apparatus and a decoding apparatus.

### BACKGROUND ART

A video coding apparatus which generates coded data by coding a video, and a video decoding apparatus which generates decoded images by decoding the coded data are used for efficient transmission or recording of videos.

Specific video coding schemes include, for example, H.264/AVC and an H.265/High-Efficiency Video Coding (HEVC) scheme, and the like.

In such a video coding scheme, images (pictures) constituting a video are managed in a hierarchical structure including slices obtained by splitting an image, coding tree units (CTUs) obtained by splitting a slice, units of coding (which may also be referred to as coding units (CUs)) obtained by splitting a coding tree unit, and transform units (TUs) obtained by splitting a coding unit, and are coded/decoded for each CU.

In such a video coding scheme, usually, a prediction image is generated based on a local decoded image that is obtained by coding/decoding an input image (a source image), and prediction errors (which may be referred to also as “difference images” or “residual images”) obtained by subtracting the prediction image from the input image are coded. Generation methods of prediction images include an inter-picture prediction (inter prediction) and an intra-picture prediction (intra prediction).

In addition, the recent technology for video coding and decoding includes NPL 1.

NPL 1 defines a Reference Picture Re-sampling (RPR) technique that enables coding and decoding of a variable image resolution. Furthermore, Annex D of NPL 1 defines supplemental enhancement information SEI for transmitting properties of an image, a display method, timing, and the like simultaneously with coded data.

NPL 2 proposes a technique for super-resolving a video using multiple model parameters. The quality of a video is improved by selecting and using a model parameter suitable for a target picture. The model parameter used in NPL 2 is weight s of a neural network used in a resolution enhancement method using the neural network. NPL 2 allows output of an image that is less blurry and is close to the original image as compared with known processing using an up-sampling filter and one neural network.

### CITATION LIST

### Non Patent Literature

NPL 1: ITU-T Recommendation H.266 (08/20) 2020-08-29
NPL 2: T. Hori, Z. Gong, H. Watanabe, T. Ikai, T. Chujoh, E. Sasaki, and N. Ito, “CNN-based Super-Resolution Adapted to Quantization Parameters”, International Workshop on Advanced Image Technology, IWAIT 2020, No. 42, January 2020.

### SUMMARY OF INVENTION

### Technical Problem

However, in a case that an input image is coded and decoded with the resolution of at least a part of the input image reduced using the RPR in NPL 1 or the like and restore the image to the original resolution (the same resolution as that of the input image), a problem is that the image is likely to be blurred.

In the method disclosed in NPL 2, a model parameter suitable for a video is selected from a set of prescribed model parameters and is applied. Thus, in a case that a video needs to be processed that is not suitable for multiple model parameters prepared, the processed video may have low quality. In a case that many model parameters are prepared in order to cope with various videos, a great deal of time and labor are required.

The quality of a video can be improved by appropriately weighting and integrating multiple model parameters (second model parameters) to create and use a new model parameter (first model parameter). Derivation of the first model parameter requires acquisition of information for the derivation from the input video. Thus, the video coding apparatus needs to acquire, from the input video, information for deriving the first model parameter, and to signal the information to the video decoding apparatus.

### Solution to Problem

An aspect of the present invention provides a video decoding apparatus including an image decoding apparatus configured to decode coded data obtained by coding an image subjected to resolution conversion and filter information for deriving a first model parameter, and a post-processing apparatus configured to convert the image decoded by the image decoding apparatus into an image with the same resolution as an input image.

The post-processing apparatus includes a second model parameter and creates a first model parameter by using the second model parameter and the filter information decoded.

### Advantageous Effects of Invention

Such a configuration can dynamically create a model parameter suitable for an input image, enabling image quality improvement suitable for diverse videos. This allows higher-quality videos to be transmitted than in a case that prescribed model parameters are used.

### BRIEF DESCRIPTION OF DRAWINGS

FIG. 1 is a schematic diagram illustrating a configuration of a video transmission system according to the present embodiment.

FIG. 2 is a diagram illustrating configurations of a transmission apparatus equipped with a video coding apparatus and a reception apparatus equipped with a video decoding apparatus according to the present embodiment. PROD_A illustrates the transmission apparatus equipped with the video coding apparatus, and PROD_B illustrates the reception apparatus equipped with the video decoding apparatus.

FIG. 3 is a diagram illustrating configurations of a recording apparatus equipped with the video coding apparatus and a reconstruction apparatus equipped with the video decoding apparatus according to the present embodiment. PROD_C illustrates the recording apparatus equipped with the video coding apparatus, and PROD_D illustrates the reconstruction apparatus equipped with the video decoding apparatus.

FIG. 4 is a diagram illustrating a hierarchical structure of coded data.

FIG. 5 is a conceptual diagram of an image to be processed in the video transmission system according to the present embodiment.

FIG. 6 is a conceptual diagram illustrating an example of reference pictures and reference picture lists.

FIG. 7 is a schematic diagram illustrating a configuration of an image decoding apparatus.

FIG. 8 is a flowchart illustrating general operation of the image decoding apparatus.

FIG. 9 is a schematic diagram illustrating a configuration of an inter prediction parameter derivation unit.

FIG. 10 is a schematic diagram illustrating a configuration of an inter prediction image generation unit.

FIG. 11 is a block diagram illustrating a configuration of an image coding apparatus.

FIG. 12 is a diagram illustrating a configuration example of a post-processing apparatus according to an embodiment.

FIG. 13 is a diagram illustrating a configuration example of a syntax table defining filter information according to an embodiment.

FIG. 14 is a diagram illustrating processing for deriving a first model parameter according to an embodiment.

FIG. 15 is a diagram of an applied embodiment illustrating an example of a syntax table defining filter information used in a case including a pattern in which the pre-processing apparatus does not perform resolution conversion processing.

FIG. 16 is a diagram of an applied embodiment illustrating derivation processing for a first model parameter in a case including a pattern in which the pre-processing apparatus does not perform the resolution conversion processing.

FIG. 17 is a diagram illustrating the structure of model parameters used in an embodiment.

FIG. 18 is a diagram illustrating the structure of model parameters used in an embodiment.

### DESCRIPTION OF EMBODIMENTS

### First Embodiment

Hereinafter, an embodiment of the present invention will be described with reference to the drawings.

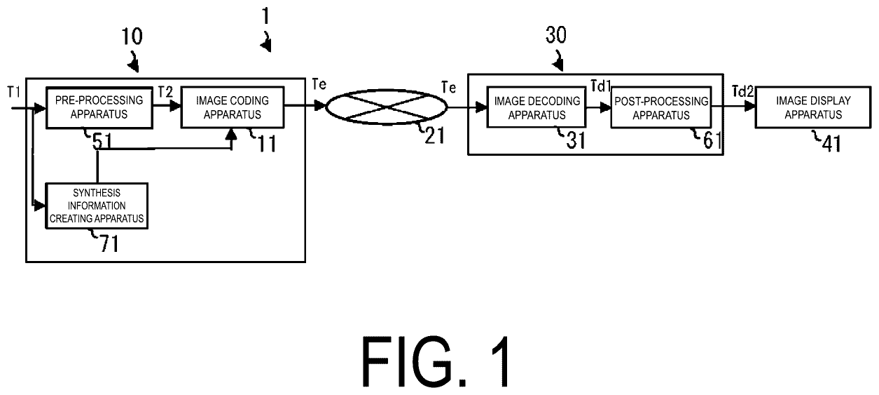

FIG. 1 is a schematic diagram illustrating a configuration of a video transmission system according to the present embodiment.

The video transmission system 1 is a system for transmitting coded data obtained by coding images of different resolutions resulting from conversion of resolution, decoding the coding stream transmitted, and decoding the transmitted coded data to inversely convert the image into an image with the original resolution for display. The video transmission system 1 includes a video coding apparatus 10, a network 21, a video decoding apparatus 30, and an image display apparatus 41.

The video coding apparatus 10 includes a pre-processing apparatus (pre-processing unit) 51, an image coding apparatus (image coder) 11, and a composite information creating apparatus (composite information creating unit) 71.

The video decoding apparatus 30 includes an image decoding apparatus (image decoder) 31 and a post-processing apparatus (post-processing unit) 61.

The pre-processing apparatus 51 converts the resolution of an image T included in a video, as necessary, and supplies, to the image coding apparatus 11, a variable resolution video T2 including the images with different resolutions. The pre-processing apparatus 51 may supply, to the image coding apparatus 11, filter information indicating the presence or absence of resolution conversion of the image. In a case that the information indicates resolution conversion, the video coding apparatus 10 sets ref_pic_resampling_enabled_flag described below equal to 1. Then, the video coding apparatus 10 performs coding using a Sequence Parameter Set SPS of coded data Te.

The composite information creating apparatus 71 creates the filter information, based on an image T1 included in the video and sends the filter information to the image coding apparatus 11.

The variable resolution image T2 is input to the image coding apparatus 11. The image coding apparatus 11 codes image size information of the input image on a per-PPS basis using the framework of the RPR, and transmits the coded image size information to the image decoding apparatus 31.

The network 21 transmits coded filter information and coded data Te to the image decoding apparatus 31. Part or all of the coded filter information may be included in the coded data Te as supplemental enhancement information SEI. The network 21 is the Internet, a Wide Area Network (WAN), a Local Area Network (LAN), or a combination thereof. The network 21 is not necessarily limited to a bidirectional communication network, and may be a unidirectional communication network configured to transmit broadcast waves of digital terrestrial television broadcasting, satellite broadcasting of the like. The network 21 may be substituted by a storage medium in which the coded data Te is recorded, such as a Digital Versatile Disc (DVD: trade name) or a Blue-ray Disc (BD: trade name).

The image decoding apparatus 31 decodes each of the coded data Te transmitted by the network 21 and generates and supplies a variable resolution decoded image to a post-processing apparatus 61.

In a case that the filter information indicates resolution conversion, the post-processing apparatus 61 performs super-resolution processing using a model parameter for super-resolution, based on the image size information included in the coded data. Then, the resolution-converted image is inversely converted to generate a decoded image of the original size. In a case that the filter information does not indicate resolution conversion, image reconstruction processing using a model parameter for image reconstruction is performed. By performing image reconstruction processing, a decoded image with reduced coding noise is generated.

The image display apparatus 41 displays all or part of the one or multiple decoded images Td2 input from the post-processing apparatus 61. For example, the image display apparatus 41 includes a display device such as a liquid crystal display and an organic Electro-Luminescence (EL) display. Forms of the display include a stationary type, a mobile type, an HMD type, and the like. In a case that the image decoding apparatus 31 has a high processing capability, an image having high image quality is displayed, and in a case that the apparatus has a lower processing capability, an image which does not require high processing capability and display capability is displayed.

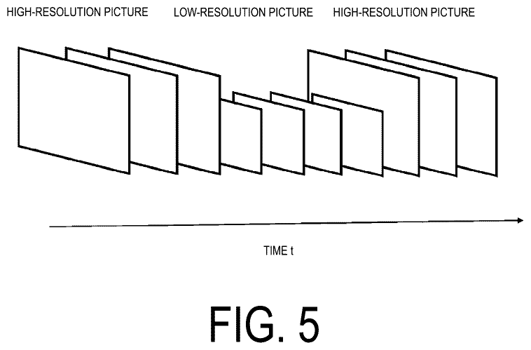

FIG. 5 is a conceptual diagram of an image to be processed in the video transmission system 1 illustrated in FIG. 1, and is a diagram illustrating a change in resolution of the image over time. Note that, FIG. 5 does not distinguish whether the image is coded. FIG. 5 illustrates an example in which, during the processing process of the video transmission system, an image with the resolution reduced is transmitted to the image decoding apparatus 31. As illustrated in FIG. 5, typically, the image pre-processing apparatus 51 performs a conversion for reducing the resolution of the image to decrease the amount of information to be transmitted.

### Operator

Operators used in the present specification will be described below.

>>is a right bit shift, << is a left bit shift, & is a bitwise AND, | is a bitwise OR, |= is an OR assignment operator, and ∥ indicates a logical sum.

x?y: z is a ternary operator that takes y in a case that x is true (other than 0) and takes z in a case that x is false (0).

Clip3 (a, b, c) is a function to clip c in a value of a to b, and a function to return a in a case that c is less than a (c<a), return b in a case that c is greater than b (c>b), and return c in the other cases (provided that a is less than or equal to b (a<=b)).

abs (a) is a function that returns the absolute value of a.

Int (a) is a function that returns the integer value of a.

floor (a) is a function that returns the maximum integer equal to or less than a.

ceil (a) is a function that returns the minimum integer equal to or greater than a.

a/d represents division of a by d (round down decimal places).

### Structure of Coded Data Te

Prior to the detailed description of the image coding apparatus 11 and the image decoding apparatus 31 according to the present embodiment, a data structure of the coded data Te generated by the image coding apparatus 11 and decoded by the image decoding apparatus 31 will be described.

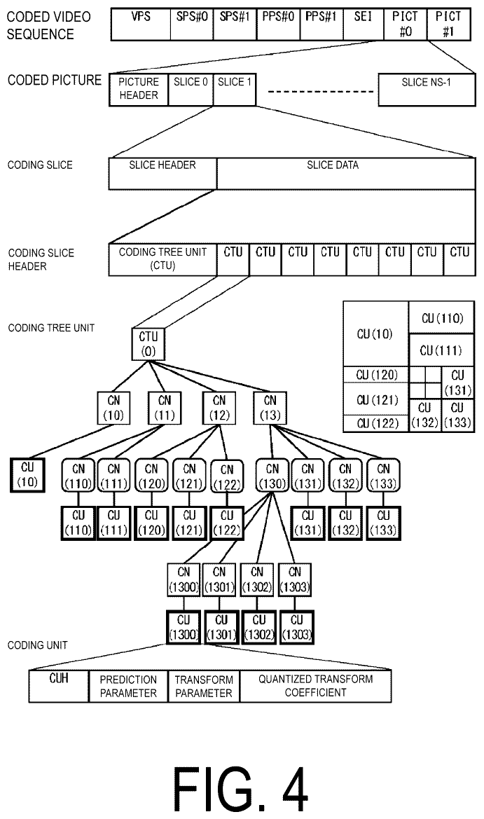

FIG. 4 is a diagram illustrating a hierarchical structure of data of the coded data Te. The coded data Te includes a sequence and multiple pictures constituting the sequence illustratively. FIG. 4 is a diagram illustrating a coded video sequence defining a sequence SEQ, a coded picture prescribing a picture PICT, a coding slice prescribing a slice S, a coding slice data prescribing slice data, a coding tree unit included in the coding slice data, and a coding unit included in the coding tree unit.

### Coded Video Sequence

In the coded video sequence, a set of data referred to by the image decoding apparatus 31 to decode the sequence SEQ to be processed is defined. As illustrated in FIG. 4, the sequence SEQ includes a Video Parameter Set VPS, a Sequence Parameter Set SPS, a Picture Parameter Set PPS, an Adaptation Parameter Set (APS), a picture PICT, and Supplemental Enhancement Information SEI.

In the video parameter set VPS, in a video including multiple layers, a set of coding parameters common to multiple videos and a set of coding parameters associated with the multiple layers and an individual layer included in the video are defined.

In the sequence parameter set SPS, a set of coding parameters referred to by the image decoding apparatus 31 to decode a target sequence is defined. For example, a width and a height of a picture are defined. Note that multiple SPSs may exist. In that case, any of the multiple SPSs is selected from the PPS.

Here, the sequence parameter set SPS includes the following syntax elements.
ref_pic_resampling_enabled_flag: A flag specifying whether to use a function of making the resolution variable (resampling) in a case of decoding images included in a single sequence referencing a target SPS. From another aspect, the flag indicates that the size of the reference picture referenced in the generation of the prediction image changes between the images indicated by the single sequence. In a case that the value of the flag is 1, the above resampling is applied, and in a case that the value is 0, the resampling is not applied.
pic_width_max_in_luma_samples: A syntax element indicating, in units of luma blocks, the width of one of the images in a single sequence, the image having the largest width. The syntax element is required to have a value that is not 0 and that is an integer multiple of Max(8, MinCbSizeY). Here, MinCbSizeY is a value determined by the minimum size of the luma block.
pic_height_max_in_luma_samples: A syntax element indicating, in units of luma blocks, the height of one of the images in a single sequence, the image having the largest height. The syntax element is required to have a value that is not 0 and that is an integer multiple of Max(8, MinCbSizeY).
sps_temporal_mvp_enabled_flag: A flag specifying whether to use a temporal motion vector prediction in the case of decoding a target sequence. In a case that the value of the flag is 1, the temporal motion vector prediction is used, and in a case that the value is 0, the temporal motion vector prediction is not used. With this flag defined, in a case that reference pictures with different resolutions are referenced or in other such cases, coordinate positions to be referenced can be prevented from being misaligned.

In the picture parameter set PPS, a set of coding parameters referred to by the image decoding apparatus 31 to decode each picture in a target sequence is defined. For example, a reference value (pic_init_qp_minus26) of a quantization step size used for decoding of a picture and a flag (weighted_pred_flag) indicating an application of a weighted prediction are included. Note that multiple PPSs may exist. In that case, any of the multiple PPSs is selected from each picture in a target sequence.

Here, the picture parameter set PPS includes the following syntax elements.
pic_width_in_luma_samples: A syntax element indicating the width of a target picture. The syntax element is required to have a value that is not 0 and that is an integer multiple of Max(8, MinCbSizeY) and that is equal to or less than pic_width_max_in_luma_samples.
pic_height_in_luma_samples: A syntax element indicating the height of the target picture. The syntax element is required to have a value that is not 0 and that is an integer multiple of Max(8, MinCbSizeY) and that is equal to or less than pic_height_max_in_luma_samples.
conformance_window_flag: A flag indicating whether a conformance (cropping) window offset parameter is subsequently signaled. The conformance window offset parameter indicates where to display the conformance window. In a case that the flag is 1, the parameter is signaled, and in a case that the flag is 0, the parameter is not present.
conf_win_left_offset, conf_win_right_offset, conf_win_top_offset, conf_win_bottom_offset: An offset value indicating, for a rectangular region indicated in picture coordinates for output, the left, right, top, and bottom positions of a picture output in decoding processing. In a case that the value of the conformance_window_flag is 0, the values of conf_win_left_offset, conf_win_right_offset, conf_win_top_offset, conf_win_bottom_offset are inferred to be 0.
scaling_window_flag: A flag indicating whether a scaling window offset parameter is present in the target PPS, the flag being related to specification of an output image size. The flag being 1 indicates that the parameter is present in the PPS, and the flag being 0 indicates that the parameter is not present in the PPS. In a case that the value of ref_pic_resampling_enabled_flag is 0, then the value of scaling_window_flag is required to be 0.
scaling_win_left_offset, scaling_win_right_offset, scaling_win_top_offset, scaling_win_bottom_offset: A syntax element indicating an offset applied to the image size for scaling ratio calculation, in luma sample units for the left, right, top, and bottom positions of the target picture. In a case that the value of the scaling_window_flag is 0, the values of scaling_win_left_offset, scaling_win_right_offset, scaling_win_top_offset, scaling_win_bottom_offset are inferred to be 0. The value of scaling_win_left_offset+scaling_win_right_offset is required to be less than pic_width_in_luma_samples, and the value of scaling_win_top_offset+scaling_win_bottom_offset is required to be less than pic_height_in_luma_samples.

The width PicOutputWidthL and the height PicOutputHeightL of the output picture are derived as described below.

PicOutputWidthL=pic . . . width . . . in . . . luma . . . samples−(scaling . . . win . . . right . . . of fset+scaling . . . win . . . left . . . offset)

PicOutputHeightL=pic . . . height . . . in . . . pic . . . size . . . units−(scaling . . . win . . . bott om . . . offset+scaling . . . win . . . top . . . offset)

### Coded Picture

In the coded picture, a set of data referred to by the image decoding apparatus 31 to decode the picture PICT to be processed is defined. As illustrated in FIG. 4, the picture PICT includes a picture header PH and slices 0 to NS-1 (NS is the total number of slices included in the picture PICT).

In the description below, in a case that the slices 0 to NS-1 need not be distinguished from one another, subscripts of reference signs may be omitted. The same applies to other data with subscripts included in the coded data Te which will be described below.

The picture header includes the following syntax elements.
pic_temporal_mvp_enabled_flag: A flag specifying whether a temporal motion vector prediction is used for an inter prediction of a slice associated with the picture header. In a case that the value of the flag is 0, the syntax element of a slice associated with the picture header is restricted such that the temporal motion vector prediction is not used to decode the slice. The value of the flag being 1 indicates that the temporal motion vector prediction is used to decode the slice associated with the picture header. In a case that the flag is not specified, the value is inferred to be 0.

### Coding Slice

In the coding slice, a set of data referred to by the image decoding apparatus 31 to decode the slice S to be processed is defined. As illustrated in FIG. 4, the slice includes a slice header and slice data.

The slice header includes a coding parameter group referenced by the image decoding apparatus 31 to determine a decoding method for a target slice. Slice type indication information (slice_type) indicating a slice type is one example of a coding parameter included in the slice header.

Examples of slice types that can be indicated by the slice type indication information include (1) I slices for which only an intra prediction is used in coding, (2) P slices for which a uni-prediction (L0 prediction) or an intra prediction is used in coding, and (3) B slices for which a uni-prediction (L0 prediction or L1 prediction), a bi-prediction, or an intra prediction is used in coding, and the like. Note that the inter prediction is not limited to a uni-prediction and a bi-prediction, and the prediction image may be generated by using a larger number of reference pictures. Hereinafter, in a case of being referred to as the P or B slice, a slice that includes a block in which the inter prediction can be used is indicated.

Note that the slice header may include a reference to the picture parameter set PPS (pic_parameter_set_id).

### Coding Slice Data

In the coding slice data, a set of data referenced by the image decoding apparatus 31 to decode the slice data to be processed is defined. The slice data includes CTUs as illustrated in the coding slice header in FIG. 4. The CTU is a block of a fixed size (for example, 64×64) constituting a slice, and may also be called a Largest Coding Unit (LCU).

### Coding Tree Unit

In FIG. 4, a set of data is defined that is referenced by the image decoding apparatus 31 to decode the CTU to be processed. The CTU is split into coding units CUs, each of which is a basic unit of coding processing, by a recursive Quad Tree split (QT split), Binary Tree split (BT split), or Ternary Tree split (TT split). The BT split and the TT split are collectively referred to as a Multi Tree split (MT split). Nodes of a tree structure obtained by recursive quad tree splits are referred to as Coding Nodes. Intermediate nodes of a quad tree, a binary tree, and a ternary tree are coding nodes, and the CTU itself is also defined as the highest coding node.

The CT includes, as CT information, a CU split flag (split_cu_flag) indicating whether or not to perform a CT split, a QT split flag (qt_split_cu_flag) indicating whether or not to perform a QT split, an MT split direction (mtt_split_cu_vertical_flag) indicating a split direction of an MT split, and an MT split type (mtt_split_cu_binary_flag) indicating a split type of the MT split. split_cu_flag, qt_split_cu_flag, mtt_split_cu_vertical_flag, and mtt_split_cu_binary_flag are transmitted for each coding node.

### Coding Unit

In FIG. 4, a set of data referenced by the image decoding apparatus 31 to decode the coding unit to be processed is defined. Specifically, the CU includes a CU header CUH, a prediction parameter, a transform parameter, a quantized transform coefficient, and the like. In the CU header, a prediction mode and the like are defined.

There are cases that the prediction processing is performed in units of CU or performed in units of sub-CU in which the CU is further split. In a case that the sizes of the CU and the sub-CU are equal to each other, the number of sub-CUs in the CU is one. In a case that the CU is larger in size than the sub-CU, the CU is split into sub-CUs. For example, in a case that the CU has a size of 8×8, and the sub-CU has a size of 4×4, the CU is split into four sub-CUs which include two horizontal splits and two vertical splits.

There are two types of predictions (prediction modes), which are intra prediction and inter prediction. The intra prediction refers to a prediction in an identical picture, and the inter prediction refers to prediction processing performed between different pictures (for example, between pictures of different display times, and between pictures of different layer images).

Transform and quantization processing is performed in units of CU, but the quantized transform coefficient may be subjected to entropy coding in units of subblock such as 4×4.

### Prediction Parameter

A prediction image is derived by prediction parameters accompanying a block. The prediction parameters include prediction parameters for intra prediction and inter prediction.

The prediction parameters for inter prediction will be described below. The inter prediction parameters include prediction list utilization flags predFlagL0 and predFlagL1, reference picture indexes refldxL0 and refldxL1, and motion vectors mvL0 and mvL1. predFlagL0 and predFlagL1 are flags indicating whether reference picture lists (L0 list and L1 list) are used, and in a case that the value of each of the flags is 1, a corresponding reference picture list is used. Note that, in a case that the present specification mentions “a flag indicating whether or not XX”, a flag being other than 0 (for example, 1) assumes a case of XX, and a flag being 0 assumes a case of not XX, and 1 is treated as true and 0 is treated as false in a logical negation, a logical product, and the like (hereinafter, the same is applied). However, other values can be used for true values and false values in real apparatuses and methods.

For example, syntax elements to derive the inter prediction parameters include an affine flag affine_flag, a merge flag merge_flag, a merge index merge_idx, and an MMVD flag mmvd_flag that are used in the merge mode, an inter prediction indicator inter_pred_idc and a reference picture index refldxLX that are used to select a reference picture in the AMVP mode, a prediction vector index mvp_LX_idx, a difference vector mvdLX, and a motion vector precision mode amvr_mode that are used to derive a motion vector.

### Reference Picture List

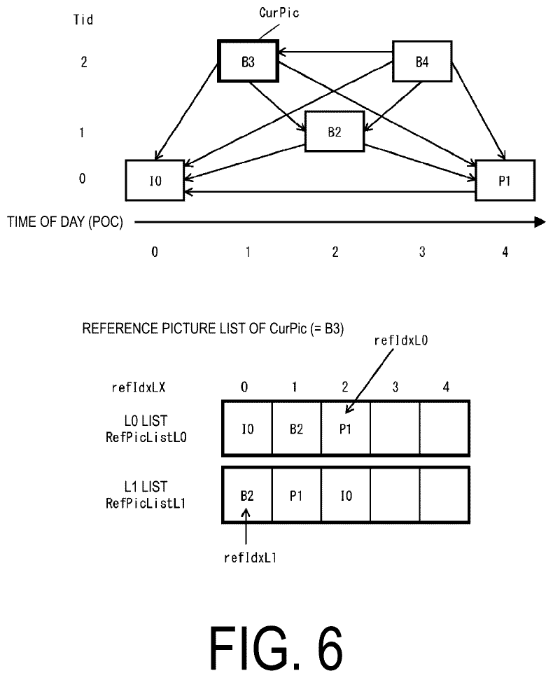

A reference picture list is a list including reference pictures stored in a reference picture memory 306. FIG. 6 is a conceptual diagram illustrating an example of reference pictures and reference picture lists. In FIG. 6 corresponding to a conceptual diagram illustrating an example of reference pictures, rectangles indicates pictures, arrows indicates reference relationships among the pictures, a horizontal axis indicates time, I, P, and B in the rectangles respectively indicate an intra-picture, a uni-prediction picture, and a bi-prediction picture, and numbers in the rectangles indicate a decoding order. As illustrated, the decoding order of the pictures is I0, P1, B2, B3, and B4, and the display order is I0, B3, B2, B4, and P1. FIG. 6 illustrates an example of reference picture list of the picture B3 (target picture). The reference picture list is a list to represent a candidate of a reference picture, and one picture (slice) may include one or more reference picture lists. In the illustrated example, the target picture B3 includes two reference picture lists, i.e., an L0 list RefPicList0 and an L1 list RefPicList1. For individual CUs, which picture in a reference picture list RefPicListX (X=0 or 1) is actually referenced is indicated with refldxLX. The diagram illustrates an example of refldxL0=2, refldxL1=0. Note that LX is a description method used in a case of not distinguishing an L0 prediction and an L1 prediction, and in the following description, distinguishes parameters for the L0 list and parameters for the L1 list by replacing LX with L0 and L1.

### Merge Prediction and AMVP Prediction

A decoding (coding) method for prediction parameters include a merge prediction (merge) mode and an Advanced Motion Vector Prediction (AMVP) mode, and merge_flag is a flag to identify the modes. The merge prediction mode is a mode in which a prediction list utilization flag predFlagLX, the reference picture index refldxLX, and a motion vector mvLX are derived from prediction parameters for neighboring blocks already processed, or the like, without being included in the coded data. The AMVP mode is a mode in which inter_pred_idc, refldxLX, and mvLX are included in the coded data. Note that, mvLX is coded as mvp_LX_idx identifying a prediction vector mvpLX and a difference vector mvdLX. In addition to the merge prediction mode, an affine prediction mode and an MMVD prediction mode may be available.

inter_pred_idc is a value indicating the types and number of reference pictures, and takes any value of PRED_L0, PRED_L1, or PRED_BI. PRED_L0 and PRED_L1 indicate uni-predictions which use one reference picture managed in the L0 list and one reference picture managed in the L1 list, respectively. PRED_BI indicates a bi-prediction which uses two reference pictures managed in the L0 list and the L1 list.

merge_idx is an index to indicate which prediction parameter is used as a prediction parameter for the target block, among prediction parameter candidates (merge candidates) derived from blocks of which the processing is completed.

### Motion Vector

mvLX indicates a shift amount between blocks in two different pictures. A prediction vector and a difference vector related to mvLX are respectively referred to as mvpLX and mvdLX.

Inter Prediction Indicator inter_pred_idc and Prediction List Utilization Flag predFlagLX

Relationships between inter_pred_idc and predFlagL0 and predFlagL1 are as follows, and can be transformed into one another.

$$\begin{matrix}inter\_pred \_idc = ( predFlagL 1 ≪ 1 ) + predFlagL θ \\ predFlagL θ = inter\_pred \_idc \& 1 \\ predFlagL 1 = inter\_pred \_idc ≫ 1\end{matrix}$$

### Configuration of Image Decoding Apparatus

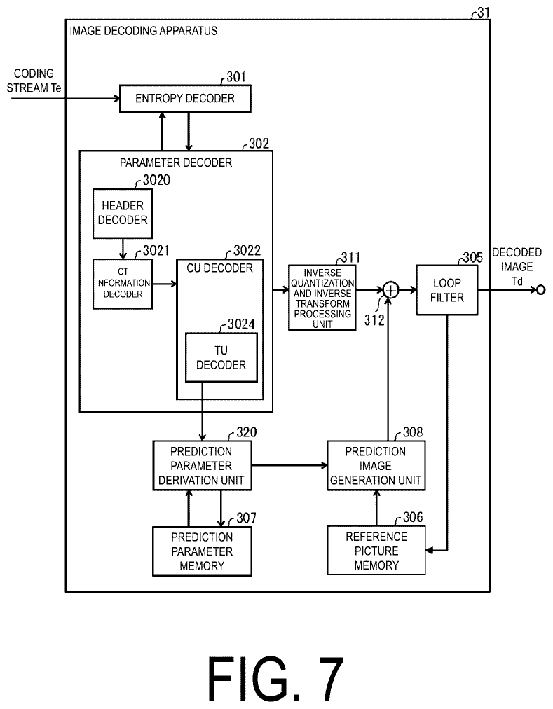

The configuration of the image decoding apparatus 31 (FIG. 7) according to the present embodiment will be described.

The image decoding apparatus 31 includes an entropy decoder 301, a parameter decoder (a prediction image decoding apparatus) 302, a loop filter 305, a reference picture memory 306, a prediction parameter memory 307, a prediction image generation unit (prediction image generation apparatus) 308, an inverse quantization and inverse transform processing unit 311, an addition unit 312, and a prediction parameter derivation unit 320. Note that a configuration in which the loop filter 305 is not included in the image decoding apparatus 31 may be used in accordance with the image coding apparatus 11 described below.

The parameter decoder 302 further includes a header decoder 3020, a CT information decoder 3021, and a CU decoder 3022 (prediction mode decoder), and the CU decoder 3022 further includes a TU decoder 3024. These may be collectively referred to as a decoding module. The header decoder 3020 decodes, from coded data, parameter set information such as the VPS, the SPS, the PPS, and an APS, and a slice header (slice information). The CT information decoder 3021 decodes a CT from coded data. The CU decoder 3022 decodes a CU from coded data. In a case that a TU includes a prediction error, the TU decoder 3024 decodes QP update information (quantization correction value) and quantization prediction error (residual_coding) from coded data.

In the mode other than the skip mode (skip_mode==0), the TU decoder 3024 decodes QP update information and quantization prediction error from coded data. More specifically, the TU decoder 3024 decodes, in a case of skip_mode==0, a flag cu_cbp indicating whether a quantization prediction error is included in the target block, and decodes the quantization prediction error in a case that cu_cbp is 1. In a case that cu_cbp is not present in the coded data, the TU decoder 3024 derives cu_cbp as 0.

The prediction image generation unit 308 includes an inter prediction image generation unit 309 and an intra prediction image generation unit 310.

The prediction parameter derivation unit 320 includes an inter prediction parameter derivation unit 303 and an intra prediction parameter derivation unit 304.

An example in which a CTU and a CU are used as units of processing is described below, but the processing is not limited to this example, and processing in units of sub-CU may be performed. Alternatively, the CTU and the CU may be replaced with a block, the sub-CU may be replaced with by a subblock, and processing may be performed in units of blocks or subblocks.

The entropy decoder 301 performs entropy decoding on the coded data Te input from the outside to decode individual codes (syntax elements).

The entropy decoder 301 outputs the decoded codes to the parameter decoder 302. The decoded code is, for example, a prediction mode predMode, merge_flag, merge_idx, inter_pred_idc, refldxLX, mvp_LX_idx, mvdLX, amvr_mode, and the like. Which code is to be decoded is controlled based on an indication of the parameter decoder 302.

### Basic Flow of Operation

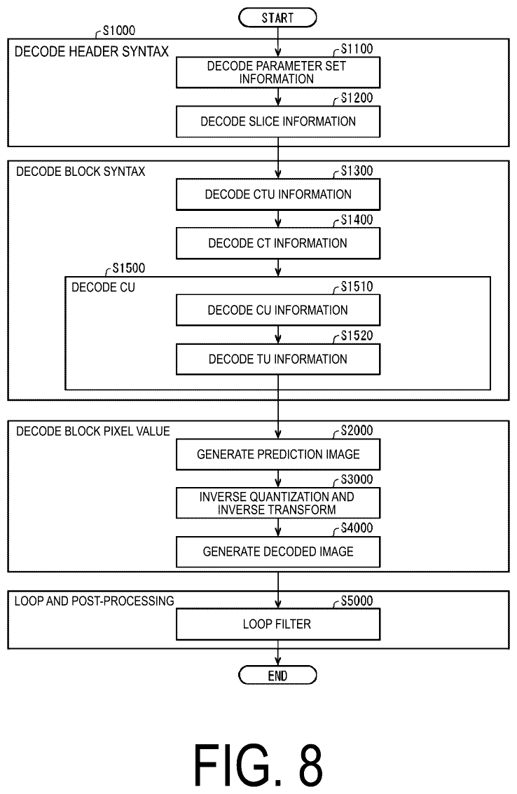

FIG. 8 is a flowchart for describing general operation performed in the image decoding apparatus 31.

(S1100: Decoding of parameter set information) The header decoder 3020 decodes parameter set information such as the VPS, the SPS, and the PPS from coded data.

(S1200: Decoding of slice information) The header decoder 3020 decodes a slice header (slice information) from the coded data.

Afterwards, the image decoding apparatus 31 repeats the processing from S1300 to S5000 for each CTU included in the target picture, and thereby derives a decoded image of each CTU.

(S1300: Decoding of CTU information) The CT information decoder 3021 decodes the CTU from the coded data.

(S1400: Decoding of CT information) The CT information decoder 3021 decodes the CT from the coded data.

(S1500: Decoding of CU) The CU decoder 3022 decodes the CU from the coded data by performing S1510 and S1520.

(S1510: Decoding of CU information) The CU decoder 3022 decodes, for example, CU information, prediction information, a TU split flag split_transform_flag, CU residual flags cbf_cb, cbf_cr, and cbf_luma from the coded data.

(S1520: Decoding of TU information) In a case that a prediction error is included in the TU, the TU decoder 3024 decodes, from the coded data, QP update information and a quantization prediction error, and transform index mts_idx. Note that the QP update information is a difference value from a quantization parameter prediction value qPpred, which is a prediction value of a quantization parameter QP.

(S2000: Generation of prediction image) The prediction image generation unit 308 generates a prediction image, based on the prediction information, for each block included in the target CU.

(S3000: Inverse quantization and inverse transform) The inverse quantization and inverse transform processing unit 311 performs inverse quantization and inverse transform processing on each TU included in the target CU.

(S4000: Generation of decoded image) The addition unit 312 generates a decoded image of the target CU by adding the prediction image supplied by the prediction image generation unit 308 and the prediction error supplied by the inverse quantization and inverse transform processing unit 311.

(S5000: Loop filter) The loop filter 305 generates a decoded image by applying a loop filter such as a deblocking filter, an SAO, and an ALF to the decoded image.

### Configuration of Inter Prediction Parameter Derivation Unit

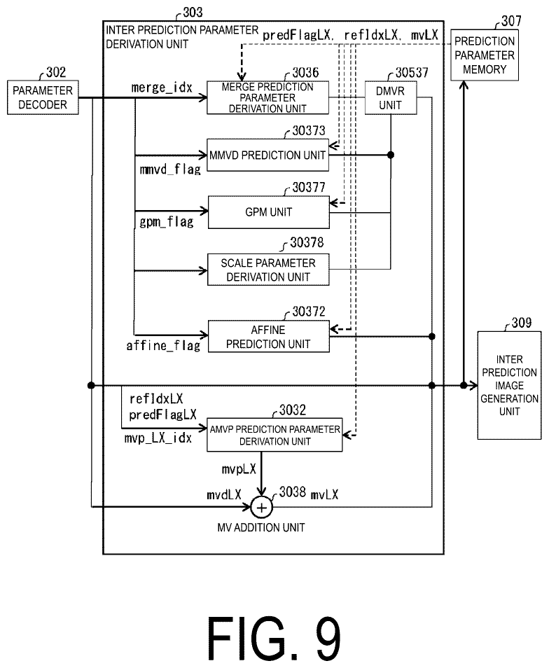

FIG. 9 is a schematic diagram illustrating a configuration of the inter prediction parameter derivation unit 303 according to the present embodiment. The inter prediction parameter derivation unit 303 derives an inter prediction parameter with reference to the prediction parameters stored in the prediction parameter memory 307, based on the syntax element input from the parameter decoder 302. The inter prediction parameter derivation unit 303 outputs the inter prediction parameter to the inter prediction image generation unit 309 and the prediction parameter memory 307. The following are components common to the image coding apparatus and the image decoding apparatus, and may thus be collectively referred to as a motion vector derivation unit (motion vector derivation apparatus): the inter prediction parameter derivation unit 303 and the internal elements of the inter prediction parameter derivation unit 303 including an AMVP prediction parameter derivation unit 3032, a merge prediction parameter derivation unit 3036, an affine prediction unit 30372, and an MMVD prediction unit 30373, a GPM prediction unit 30377, a DMVR unit 30537, and an MV addition unit 3038.

The scale parameter derivation unit 30378 derives the scaling ratio in the horizontal direction of the reference picture RefPicScale[i][U][0], the scaling ratio in the vertical direction of the reference picture RefPicScale[i][j][1], and RefPicIsScaled[i][j] indicating whether the reference picture is scaled. Here, with i indicating whether the reference picture list is an L0 list or an L1 list, and j being the value of the L0 reference picture list or the L1 reference picture list, the derivation is performed as follows.

$$\begin{matrix}RefPicScale [ i ] [ j ] [ θ ] = ( ( fRefWidth ≪ 14 ) + ( PicOutputWidthL ≫ 1 ) ) / PicOutputWidthL \\ RefPicScale [ i ] [ j ] [ 1 ] = ( ( fRefHeight ≪ 14 ) + ( PicOutputHeightL ≫ 1 ) ) / PicOutputHeightL \\ RefPicIsScaled [ i ] [ j ] = ( RefPicScale [ i ] [ j ] [ θ ] != ( 1 ≪ 14 ) ) ‖ ( RefPicScale [ i ] [ j ] [ 1 ] != ( 1 ≪ 14 ) )\end{matrix}$$

Here, the variable PicOutputWidthL is a value obtained in a case that the scaling ratio in the horizontal direction is calculated in a case that the coded picture is referenced, and is obtained by subtracting a left offset value and a right offset value from the number of pixels in the horizontal direction of the luminance of the coded picture. The variable PicOutputHeightL is a value obtained in a case that the scaling ratio in the vertical direction is calculated in a case that the coded picture is referenced, and is obtained by subtracting a top offset value and a bottom offset value from the number of pixels in the vertical direction of the luminance of the coded picture. The variable fRefWidth is the value of PicOutputWidthL of the reference picture of the reference list value j in the list i, and the variable fRefHight is the value of PicOutputHeightL of the reference picture of the reference picture list value j in the list i.

In a case that the affine_flag indicates 1, that is, the affine prediction mode, the affine prediction unit 30372 derives the inter prediction parameters in subblock units.

In a case that the mmvd_flag indicates 1, that is, the MMVD prediction mode, the MMVD prediction unit 30373 derives an inter prediction parameter from the merge candidate and the difference vector derived by the merge prediction parameter derivation unit 3036.

In a case that gpm_flag indicates 1, that is, a Geometric Partitioning Mode, the GPM unit 30377 derives a GPM parameter.

In a case that merge_flag indicates 1, that is, the merge prediction mode, merge_idx is derived and output to the merge prediction parameter derivation unit 3036.

In a case that the merge_flag indicates 0, that is, the AMVP prediction mode, the AMVP prediction parameter derivation unit 3032 derives mvpLX from inter_pred_idc, refldxLX, or mvp_LX_idx.

### MV Addition Unit

In the MV addition unit 3038, mvpLX and mvdLX derived are added together to derive mvLX.

### Affine Prediction Unit

The affine prediction unit 30372 derives 1) motion vectors for two control points CP0, CP1 or three control points CP0, CP1, CP2 of the target block, 2) derives affine prediction parameters for the target block, and 3) derives a motion vector for each subblock from the affine prediction parameter.

### Merge Prediction

The merge prediction parameter derivation unit 3036 derives a prediction parameter for the target block by using prediction parameters (mvLX, refldxLX, and the like) for a spatial neighboring block or a temporal neighboring block of the target block.

### DMVR

Subsequently, the DMVR unit 30375 performs Decoder side Motion Vector Refinement (DMVR) processing. In a case that the merge_flag is 1 or the skip flag skip_flag is 1 for the target CU, the DMVR unit 30375 refines a motion vector mvLX of the target CU. Specifically, in a case that the prediction parameter derived by the merge prediction unit 30374 indicates bi-prediction, mvLX is refined by using the prediction image derived from the two reference pictures and the motion vector. mvLX refined is supplied to the inter prediction image generation unit 309.

### AMVP Prediction

The AMVP prediction parameter derivation unit 3032 selects, as mvpLX, a motion vector mvpListLX[mvp_LX_idx] indicated by mvp_LX_idx, among the prediction vector candidates, and outputs the motion vector mvpListLX[mvp_LX_idx] to the MV addition unit 3038.

### MV Addition Unit

The MV addition unit 3038 adds mvpLX input from the AMVP prediction parameter derivation unit 3032 and mvdLX decoded, to calculate mvLX. The addition unit 3038 outputs mvLX calculated to the inter prediction image generation unit 309 and the prediction parameter memory 307.

$$\begin{matrix}mvLX [ θ ] = mvpLX [ θ ] + mvdLX [ θ ] \\ mvLX [ 1 ] = mvpLX [ 1 ] + mvdLX [ 1 ]\end{matrix}$$

The loop filter 305 is a filter provided in the coding loop, and is a filter that removes block distortion and ringing distortion and improves image quality. The loop filter 305 applies a filter such as a deblocking filter, a Sample Adaptive Offset (SAO), and an Adaptive Loop Filter (ALF) on a decoded image of a CU generated by the addition unit 312.

The loop filter 305 may include a post-processing apparatus 61 to be described below. That is, the post-processing apparatus 61 to be described below may cause a neural network to use the first model parameter to derive an output image from the filter information transmitted as the coded data. The first model parameter is derived by a model integration processing.

The reference picture memory 306 stores a decoded image of the CU in a predefined position for each target picture and target CU.

The prediction parameter memory 307 stores the prediction parameter in a predefined position for each CTU or CU. Specifically, the prediction parameter memory 307 stores the parameter decoded by the parameter decoder 302, the parameter derived by the prediction parameter derivation unit 320, and the like.

Parameters derived by the prediction parameter derivation unit 320 are input to the prediction image generation unit 308. In addition, the prediction image generation unit 308 reads a reference picture from the reference picture memory 306. The prediction image generation unit 308 generates a prediction image of a block or a subblock by using the parameters and the reference picture (reference picture block) in the prediction mode indicated by predMode. Here, the reference picture block refers to a set of pixels (referred to as a block because they are normally rectangular) on a reference picture and is a region that is referenced for generating a prediction image.

### Inter Prediction Image Generation Unit 309

In a case that predMode indicates the inter prediction mode, the inter prediction image generation unit 309 generates a prediction image of a block or a subblock by inter prediction by using the inter prediction parameters input from the inter prediction parameter derivation unit 303 and the reference picture.

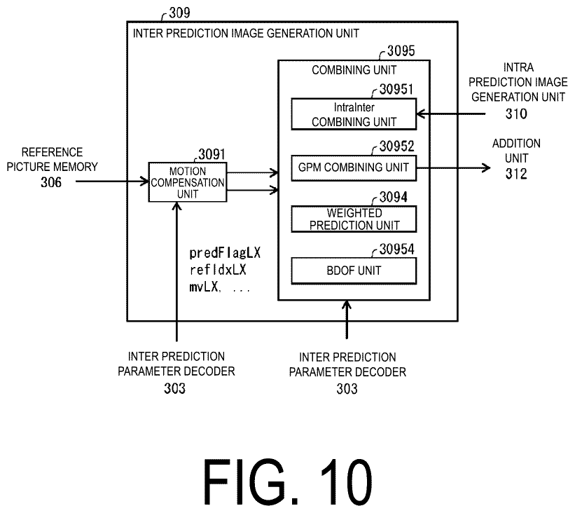

FIG. 10 is a schematic diagram illustrating a configuration of the inter prediction image generation unit 309 included in the prediction image generation unit 308 according to the present embodiment. The inter prediction image generation unit 309 includes a motion compensation unit (prediction image generation apparatus) 3091 and a combining unit 3095. The combining unit 3095 includes an IntraInter combining unit 30951, a GPM combining unit 30952, a BDOF unit 30954, and a weighted prediction unit 3094.

### Motion Compensation

The motion compensation unit 3091 (interpolation image generation unit 3091) generates an interpolation image (motion compensation image) by reading a reference block from the reference picture memory 306 based on the inter prediction parameters (predFlagLX, refldxLX, mvLX) input from the inter prediction parameter derivation unit 303. The reference block is a block located on the reference picture RefPicLX indicated by refldxLX, at a position shifted by mvLX from the position of the target block. Here, in a case that mvLX does not have an integer precision, an interpolation image is generated by using a filter referred to as a motion compensation filter and configured to generate pixels at fractional positions.

Note that the motion compensation unit 3091 has a function of scaling an interpolation image in accordance with the scaling ratio in the horizontal direction RefPicScale[i] [j][0] of the reference picture derived by the scale parameter derivation unit 30378, and the scaling ratio in the vertical direction RefPicScale[i][j][1] of the reference picture.

The combining unit 3095 includes the IntraInter combining unit 30951, the GPM combining unit 30952, the weighted prediction unit 3094, and the BDOF unit 30954.

### IntraInter Combining Processing

The IntraInter combining unit 30951 generates a prediction image through the weighted sum of an inter prediction image and an intra prediction image.

### GPM Combining Processing

The GPM combining unit 30952 generates a prediction image using the GPM described above.

### BDOF Prediction

In a bi-prediction mode, the BDOF unit 30954 generates a prediction image with reference to two prediction images (first prediction image and second prediction image) and a gradient correction term.

### Weighted Prediction

The weighted prediction unit 3094 performs weighted prediction on an interpolation image PredLX to generate a prediction image pbSamples of the block.

In a case that predMode indicates an intra prediction mode, the intra prediction image generation unit 310 performs an intra prediction by using an intra prediction parameter input from the intra prediction parameter derivation unit 304 and a reference pixel read out from the reference picture memory 306.

The inverse quantization and inverse transform processing unit 311 performs inverse quantization on a quantized transform coefficient input from the parameter decoder 302 to calculate a transform coefficient.

The addition unit 312 adds the prediction image of the block input from the prediction image generation unit 308 and the prediction error input from the inverse quantization and inverse transform processing unit 311 for each pixel, and generates a decoded image of the block. The addition unit 312 stores the decoded image of the block in the reference picture memory 306, and also outputs it to the loop filter 305.

The inverse quantization and inverse transform processing unit 311 performs inverse quantization on a quantized transform coefficient input from the parameter decoder 302 to calculate a transform coefficient.

The addition unit 312 adds the prediction image of the block input from the prediction image generation unit 308 and the prediction error input from the inverse quantization and inverse transform processing unit 311 for each pixel, and generates a decoded image of the block. The addition unit 312 stores the decoded image of the block in the reference picture memory 306, and also outputs it to the loop filter 305.

### Configuration of Image Coding Apparatus

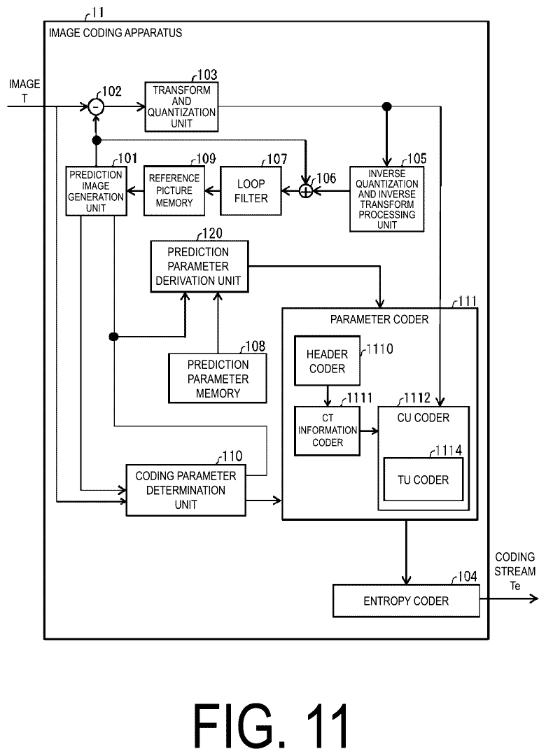

Next, a configuration of the image coding apparatus 11 according to the present embodiment will be described. FIG. 11 is a block diagram illustrating a configuration of the image coding apparatus 11 according to the present embodiment. The image coding apparatus 11 includes a prediction image generation unit 101, a subtraction unit 102, a transform and quantization unit 103, an inverse quantization and inverse transform processing unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, a parameter coder 111, a prediction parameter derivation unit 120, and an entropy coder 104.

The prediction image generation unit 101 generates a prediction image for each CU. The prediction image generation unit 101 includes the inter prediction image generation unit 309 and intra prediction image generation unit 310 already described, and description of these units is omitted.

The subtraction unit 102 subtracts a pixel value of the prediction image of a block input from the prediction image generation unit 101 from a pixel value of the image T to generate a prediction error. The subtraction unit 102 outputs the prediction error to the transform and quantization unit 103.

The transform and quantization unit 103 performs a frequency transform on the prediction error input from the subtraction unit 102 to calculate a transform coefficient, and derives a quantized transform coefficient by quantization. The transform and quantization unit 103 outputs the quantized transform coefficient to the parameter coder 111 and the inverse quantization and inverse transform processing unit 105.

The inverse quantization and inverse transform processing unit 105 is the same as the inverse quantization and inverse transform processing unit 311 (FIG. 7) in the image decoding apparatus 31, and descriptions thereof are omitted. The calculated prediction error is output to the addition unit 106.

The parameter coder 111 includes a header coder 1110, a CT information coder 1111, and a CU coder 1112 (prediction mode coder). The CU coder 1112 further includes a TU coder 1114. General operation of each module will be described below.

The header coder 1110 performs coding processing of parameters such as filter information, header information, split information, prediction information, and quantized transform coefficients.

The CT information coder 1111 codes the QT and MT (BT, TT) split information and the like.

The CU coder 1112 codes the CU information, the prediction information, the split information, and the like.

In a case that a prediction error is included in the TU, the TU coder 1114 codes the QP update information and the quantization prediction error.

The CT information coder 1111 and the CU coder 1112 supplies, to the parameter coder 111, syntax elements such as the inter prediction parameters (predMode, merge_flag, merge_idx, inter_pred_idc, refldxLX, mvp_LX_idx, mvdLX), the intra prediction parameters (intra_luma_mpm_flag, intra_luma_mpm_idx, intra_luma_mpm_reminder, intra_chroma_pred_mode), and the quantized transform coefficient.

The parameter coder 111 inputs the quantized transform coefficient and the coding parameters (split information and prediction parameters) to the entropy coder 104. The entropy coder 104 entropy-codes the quantized transform coefficient and the coding parameters to generate coded data Te and outputs the coded data Te.

The prediction parameter derivation unit 120 is a component including the inter prediction parameter coder 112 and the intra prediction parameter coder 113, and derives an intra prediction parameter and an intra prediction parameter from the parameters input from the coding parameter determination unit 110. The intra prediction parameter and intra prediction parameter derived are output to the parameter coder 111.

### Configuration of Inter Prediction Parameter Coder

The inter prediction parameter coder 112 includes a parameter coding controller 1121 and an inter prediction parameter derivation unit 303. The inter prediction parameter derivation unit 303 has a configuration common to the image decoding apparatus. The parameter coding controller 1121 includes a merge index derivation unit 11211 and a vector candidate index derivation unit 11212.

The merge index derivation unit 11211 derives merge candidates and the like, and outputs the merge candidates and the like to the inter prediction parameter derivation unit 303. The vector candidate index derivation unit 11212 derives prediction vector candidates and the like, and outputs the prediction vector candidates and the like to the inter prediction parameter derivation unit 303 and the parameter coder 111.

### Configuration of Intra Prediction Parameter Coder 113

The intra prediction parameter coder 113 includes a parameter coding control unit 1131 and the intra prediction parameter derivation unit 304. The intra prediction parameter derivation unit 304 has a configuration common to the image decoding apparatus.

The parameter coding controller 1131 derives IntraPredModeY and IntraPredModeC. Furthermore, with reference to mpmCandList[ ], intra_luma_mpm_flag is determined. These prediction parameters are output to the intra prediction parameter derivation unit 304 and the parameter coder 111.

However, unlike in the image decoding apparatus, the coding parameter determination unit 110 and the prediction parameter memory 108 provide input to the inter prediction parameter derivation unit 303 and the intra prediction parameter derivation unit 304, and output from the inter prediction parameter derivation unit 303 and the intra prediction parameter derivation unit 304 is provided to the parameter coder 111.

The addition unit 106 adds together, for each pixel, a pixel value for the prediction block input from the prediction image generation unit 101 and a prediction error input from the inverse quantization and inverse transform processing unit 105, generating a decoded image. The addition unit 106 stores the generated decoded image in the reference picture memory 109.

The loop filter 107 applies a deblocking filter, an SAO, and an ALF to the decoded image generated by the addition unit 106. Note that the loop filter 107 need not necessarily include the above-described three types of filters, and may have a configuration of only the deblocking filter, for example.

The prediction parameter memory 108 stores the prediction parameters generated by the coding parameter determination unit 110 for each target picture and CU at a predetermined position.

The reference picture memory 109 stores the decoded image generated by the loop filter 107 for each target picture and CU at a predetermined position.

The coding parameter determination unit 110 selects one set among multiple sets of coding parameters. The coding parameters include QT, BT, or TT split information described above, a prediction parameter, or a parameter to be coded which is generated related thereto. The prediction image generation unit 101 generates the prediction image by using these coding parameters.

The coding parameter determination unit 110 calculates, for each of the multiple sets, an RD cost value indicating the magnitude of an amount of information and a coding error. The RD cost value is, for example, the sum of a code amount and the value obtained by multiplying a coefficient k by a square error. The code amount is an amount of information of the coded data Te obtained by performing entropy coding on a quantization error and a coding parameter. The square error is the square sum of the prediction errors calculated in the subtraction unit 102. The coefficient k is a real number greater than a preset zero. The coding parameter determination unit 110 selects a set of coding parameters of which cost value calculated is a minimum value. The coding parameter determination unit 110 outputs the determined coding parameters to the parameter coder 111 and the prediction parameter derivation unit 120.

Note that a computer may be used to implement some of the image coding apparatus 11 and the image decoding apparatus 31 in the above-described embodiments, for example, the entropy decoder 301, the parameter decoder 302, the loop filter 305, the prediction image generation unit 308, the inverse quantization and inverse transform processing unit 311, the addition unit 312, the prediction parameter derivation unit 320, the prediction image generation unit 101, the subtraction unit 102, the transform and quantization unit 103, the entropy coder 104, the inverse quantization and inverse transform processing unit 105, the loop filter 107, the coding parameter determination unit 110, a parameter coder 111, and the prediction parameter derivation unit 120. In that case, this configuration may be realized by recording a program for realizing such control functions on a computer-readable recording medium and causing a computer system to read and perform the program recorded on the recording medium. Note that the “computer system” mentioned here refers to a computer system built into either the image coding apparatus 11 or the image decoding apparatus 31 and is assumed to include an OS and hardware components such as a peripheral apparatus. A “computer-readable recording medium” refers to a portable medium such as a flexible disk, a magneto-optical disk, a ROM, and a CD-ROM, and a storage device such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a fixed period of time, such as a volatile memory included in the computer system functioning as a server or a client in such a case. The above-described program may be one for realizing some of the above-described functions, and also may be one capable of realizing the above-described functions in combination with a program already recorded in a computer system.

Part or all of the image coding apparatus 11 and the image decoding apparatus 31 in the embodiments described above may be realized as an integrated circuit such as a Large Scale Integration (LSI). Each function block of the image coding apparatus 11 and the image decoding apparatus 31 may be individually realized as processors, or part or all may be integrated into processors. In addition, the circuit integration technique is not limited to LSI, and may be realized as dedicated circuits or a multi-purpose processor. In a case that, with advances in semiconductor technology, a circuit integration technology with which an LSI is replaced appears, an integrated circuit based on the technology may be used.

The embodiment of the present invention has been described in detail above referring to the drawings, but the specific configuration is not limited to the above embodiment and various amendments can be made to a design that fall within the scope that does not depart from the gist of the present invention.

### Model Integration

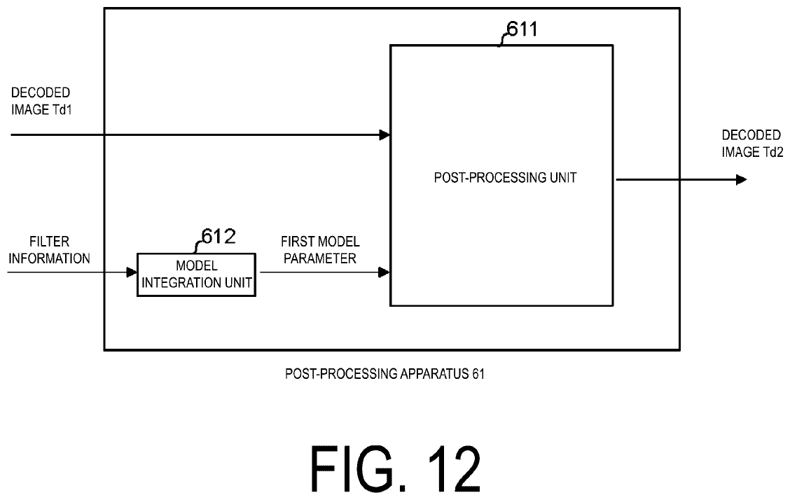

As an example of the present embodiment, an example will be described in which a parameter WeightedModel[i] (first model parameter) for a new neural network is derived using a parameter BaseModel[i] (second model parameter) for a base model neural network included in the post-processing apparatus 61 (see FIG. 12). Processing for deriving the first model parameters is referred to herein as “model integration”.

The first model parameter is derived by using linear combination (weighted average) of the second model parameter.

In the present embodiment, the weighting coefficient weight_coeff[i], which is the weight of the weighted average in the model integration, and the like, are transmitted from the video coding apparatus 10 to the video decoding apparatus 30 as the coded data. The coded data of the filter information may be transmitted as the SPS, the PPS, the APS, the picture header, the slice header, or the SEI. The SPS, the PPS and the picture header, and the slice header are sets of sequence-level, picture-level, and slice-level parameters, respectively. The APS is a parameter set corresponding to a collection of data applicable to multiple pictures. The SEI is a set of parameters for display and post-processing.

Note that in this specification, the weighting coefficient, bias, and other parameters for the neural network are not distinguished from one another and are simply referred to as model parameters. The number of model parameters is represented by NumberOfParameters.

### Examples of Syntax

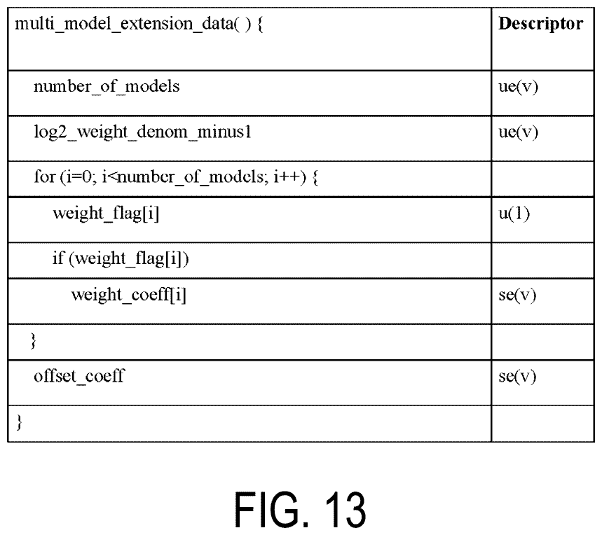

FIG. 13 is a diagram illustrating an example of syntax of coded data (filter information) for post-processing or loop filter processing according to the present embodiment.

The coded data defining the filter information may include the following syntax elements.
number_of_models: Indicates the number of BaseModels[i] provided in the post-processing apparatus 61. number_of_models is a positive integer of 1 or more. For example, for eight models, number_of_models has a value of 8. Instead of number_of_models, the number of models−1 may be coded as number_of_models_minus1.
log 2_weight_denom_minus1: an integer indicating the accuracy of the weighting coefficient. The weighting coefficient weight_coeff[i] is a fixed-point number with 1/(1<<log 2_weight_denom_minus_1+1) as a unit.
weight_flag[i]: A flag indicating whether the weighting coefficient is other than 0 (i=0. number_of_models−1). Each of the elements is represented by a 1 bit of 1 or 0, and in a case that weight_flag[i] is 0, 0 is assigned to weight_coeff[i]. weight_flag[i] needs to contain at least one element having a value of 1.
weight_coeff[i]: A weighting coefficient used to derive the first model parameter (i=0. number_of_models−1). Each element is an integer. Here, se(v) indicates that binarization is used to code a value including a negative weighting coefficient as coded data.
offset_coeff: Indicates a constant term (bias) of a linear sum used to derive the first model parameter. offset_coeff is an integer value.

The header decoder decodes a flag indicating whether the flag is non-zero. In a case that the flag indicates non-zero, the weighting coefficient is decoded by further decoding the magnitude of the weighting coefficient, and in a case that the flag indicates 0, the weighting coefficient is derived as 0. This enables decoding of the weighting coefficient coded with a small code amount.

The header decoder may decode the weighting coefficient that can take a negative value. This is effective in increasing the degree of freedom in deriving the first model parameter, derived by the subsequent model integration unit.

### Model Integration Unit 612

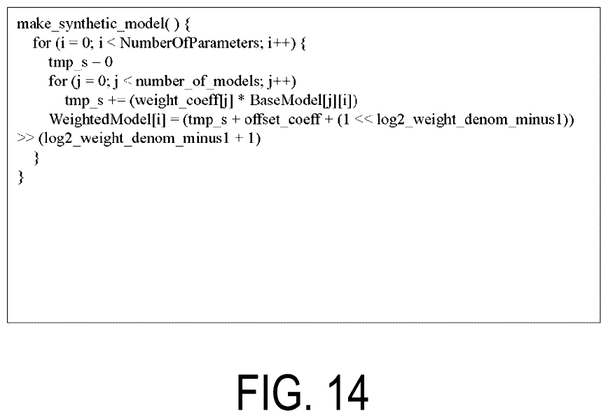

FIG. 14 illustrates an example of a method for deriving the first model parameter WeightedModel using the syntax in FIG. 12. The model integration unit 612 derives WeightedModel from weight_coeff[j] for the model j, obtained by decoding coded data, and BaseModel[j], which is a model parameter of the model j provided in advance in the model integration unit 612.

$$WeightedModel [ i ] = ( \sum ( weight\_coeff [ j ] * BaseModel [ j ] [ i ] ) + offset\_coeff + ( 1 ≪ log 2 \_weight \_denom \_minus 1 ) ) ≫ ( log 2 \_weight \_denom \_minus 1 + 1 ) \qquad ( Equation Weight ‐ 1 )$$

Σ is a sum for j=0. number_of_models−1. Here, i=0. NumberOfParameters−1. NumberOfParameters indicates the number of model parameters. WeightedModel[i] derived is output to the post-processing unit 611.

Note that the addition of the offset offset_coeff may not be included as in the following equation.

$$WeightedModel [ i ] = ( \sum ( weight\_coeff [ j ] * BaseModel [ j ] [ i ] ) + ( 1 ≪ log 2 \_weight \_denom \_minus 1 ) ) ≫ ( log 2 \_weight \_denom \_minus 1 + 1 ) \qquad ( Equation Weight ‐ 2 )$$

Note that the model integration unit 612 may switch processing according to the number of cases where weight_flag[i] is not 0. In other words, in a case that there is only one model with number j==i in which weight_flag[i]==1, the model parameter for a specific BaseModel may be directly used.

```
numBaseModel = Σweight_flag[i]
    Σ is a sum for i = 0.. number_of_models − 1.
if (numBaseModel == 1) {
  if (weight_flag[i] == 1)
    WeightedModel[i] = BaseModel[i][i]
}
else {
  WeightedModel[i] = (Σ(weight_coeff[i] * BaseModel[j][i]) + offset_{—}
coeff + (1 << log2_weight_denom_minus1)) >>
(log2_weight_denom_minus1 + 1)
}
```

In a case that in the derivation of the first model parameter, weight_coeff[j] contains two or more elements having a value other than 0, the model integration unit 612 derives a weighted sum of the second model parameters. Furthermore, offset_coeff may be added to the weighted sum, and the result may be subjected to division (or shift operation) by using the value of log 2_weight_denom_minus1. In this way, the first model parameter is derived by integrating the second model parameters together. On the other hand, in a case that weight_coeff[i] contains only one element having a value other than 0 and other elements indicate 0, a specific second model parameter is used as the first model parameter. This allows a higher-quality image to be generated than the use of at least one model parameter.

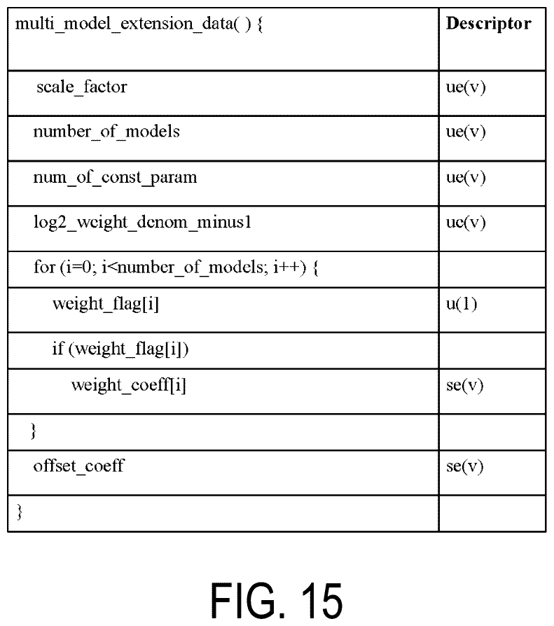

FIG. 15 is another example in which the syntax of FIG. 13 is extended. The syntax added in FIG. 15 includes the following:
scale_factor: A positive integer indicating a scaling ratio for an image. scale_factor may be, for example, a scaling ratio of 1, 2, 4, or 8. Alternatively, instead of scale_factor, log 2_ scale_factor in a logarithmic representation with base 2 may be transmitted. scale_factor=1<<log 2_scale_factor. scale_factor_divNK may be transmitted as a rational number in order to enable scaling in a unit of 1/NK. Here, scale_factor=scale_factor_divNK/NK. NK may be power of 2. scale_factor=scale_factor_divNK<<log 2(NK). NK is, for example, 2, 4, 8, 16 or the like.
num_of_const_param: Indicates the number of parameters that are not multiplied by the weighting coefficient among the model parameters.

Note that the coded data may contain either both or one of scale_factor and num_of_const_param. In a case that the coded data does not contain scale_factor or num_of_const_param, fixed values may be set to scale_factor and num_of_constparam, or the video decoding apparatus may set scale_factor and num_of_const_param equal to appropriate values.

The model integration unit 612 may derive the first model parameter by the following calculation.

$$WeightedModel [ i ] = ( \sum ( weight\_coeff [ j ] * BaseModel [ scale\_factor ] [ j ] [ i ] ) + offset\_coeff + ( 1 ≪ log 2 \_weight \_denom \_minus 1 ) ) ≫ ( log 2 \_weight \_denom \_minus 1 + 1 ) \qquad ( Equation Weight ‐ 3 )$$

In this example, the BaseModel included in the model integration unit 612 may have a different model parameter for each scaling ratio of the image. In other words, by using scale_factor to select BaseModel[scale_factor] for scale_factor, suitable model parameters can be derived for images having different resolutions. BaseModel[scale_factor][0] stores a default model parameter.

In summary, the header decoder 3020 may further decode scale_factor indicating the scale between an input image size and an output image size for the neural network, and the model integration unit 612 may derive the first model parameter by using the second model parameter varying with scale. The post-processing unit 611 may perform post-processing using a neural network partly including neural network processing (for example, an Upsampling layer) for changing the size of the image in a case that the scale factor indicates a factor other than 1.

The first model parameter may be derived using (Equation Weight-1) or (Equation Weight-2), described above, regardless of scale_factor. In this case, the method of deriving the first model parameter does not use the scaling ratio, and no second model parameter need be prepared for each scaling ratio. Therefore, the amount of memory for storing the second model parameter can be reduced. Note that by using the first model parameter, the UpSampling unit of the subsequent post-processing unit 611 may perform resolution conversion using scale_factor.

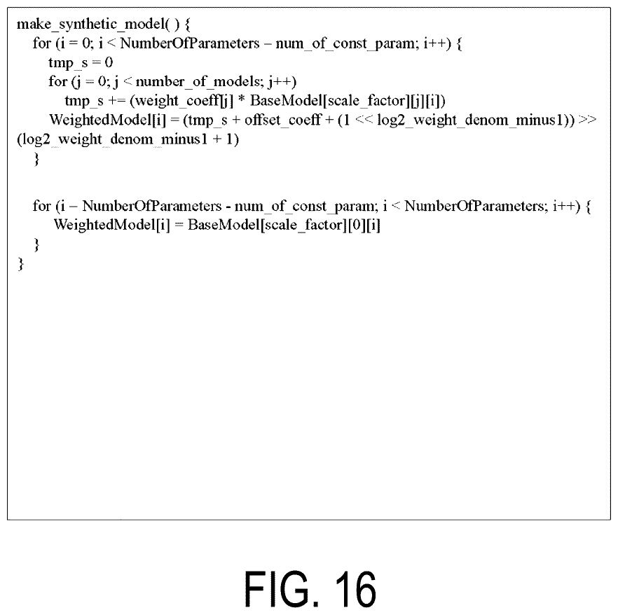

The model integration unit 612 may derive some of the first model parameters based on weighting of the BaseModel, and for the other parameters, the parameter BaseModel[scale_factor][0] for a specific BaseModel may be used without weighting. FIG. 16 illustrates an example in which for some (num_of_constparam) parameters of the NumberOfParameters parameters included in the first model parameter, parameters for the base model are directly used, and in which the other (NumberOfParameters-num_of_constparam) parameters are derived by weighting. In other words, for the num_of_const_param parameters, the model integration unit 612 derives the first model parameter without using weighting, and for the NumberOfParameters-num_of_constparam parameters, the model integration unit 612 derives the first model parameter by using weighting.

Here, any one of (Equation Weight-1), (Equation Weight-2), and (Equation Weight-3) described above may be used as the method for deriving the i=0.

NumberOfParameters_num_of_constparam-1 parameters involving weighting. The header decoder 3020 may decode information (for example, num_of_constparam) indicating the number of parameters derived without using weighting among the first model parameters.

In a configuration other than the one in which weighting is performed in the first half portion of the BaseModel (i=0. NumberOfParameters-num_of_constparam-1) and not performed in the second half portion of the BaseModel (i=NumberOfParameters-num_of_const_param. NumberOfParameters-1), weighting is not performed in the first half portion but is performed in the second half portion, or weighting is performed only in the intermediate portion.

Even in a case that weighting is not performed, in a configuration other than the one in which the model integration unit 612 substitutes BaseModel[i] into WeightedModel[i], with the post-processing unit 611 performing post-processing using WeightedModel[i], the model integration unit 612 may derive only the model parameters for the portion of the neural network that performs weighting. In this configuration, in the portion performing weighting, the post-processing unit 611 performs post-processing using the derived model parameters for the neural network, and in the portion not performing weighting, performs post-processing unit by directly using the model parameters for BaseModel[i].

The model integration unit 612 may perform weighting by using the following pseudo code.

```
for (i = 0; i < num_of_const_param; i++) {
  tmp_s = 0
  for (j = 0; i < number_of_models; j++)
    tmp_s += (weight_coeff[j] * BaseModel[scale_factor][j][i])
  WeightedModel[i] = (tmp_s + offset_coeff + (1 <<
log2_weight_denom_ minus1))
>> (log2_weight_denom_minus1 + 1)
}
for (i = num_of_const_param; i < NumberOfParameters; i++) {
  WeightedModel[i] = BaseModel[scale_factor][0][i]
}
```

Here, a configuration is illustrated in which the model integration unit 612 does not perform weighting in the first half portion but performs weighting in the second half portion. In a configuration, different BaseModels are not prepared for the respective scaling ratios. An example of the operation of the model integration unit 612 in this case will be described below. A default model parameter is stored in BaseModel[0].

```
for (i = num_of_const_param; i < NumberOfParameters; i++) {
  tmp_s = 0
  for (j = 0; j < number_of_models; j++)
    tmp_s += (weight_coeff[j] * BaseModel[j][i])
  WeightedModel[i] = (tmp_s + offset_coeff + (1 <<
log2_weight_denom_ minus1))
>> (log2_weight_denom_minus1 + 1)
}
for (i = 0; i < num_of_const_param; i++) {
  WeightedModel[i] = BaseModel[0][i]
}
```

Although not illustrated, that portion of the post-processing unit 611, described below, which corresponds to the UpSampling unit may be configured not to perform weighting.

```
for (i = 0; i < num_of_const_param; i++) {
  tmp_s = 0
  for (j = 0; j < number_of_models; j++)
    tmp_s += (weight_coeff[j] * BaseModel[j][i])
  WeightedModel[i] = (tmp_s + offset_coeff + (1 <<
log2_weight_denom_ minus1))
>> (log2_weight_denom_minus1 + 1)
}
for (i = num_of_const_param; i < NumberOfParameters; i ++) {//
corresponds to the upsampling unit
  WeightedModel[i] = BaseModel[0][i]
}
```

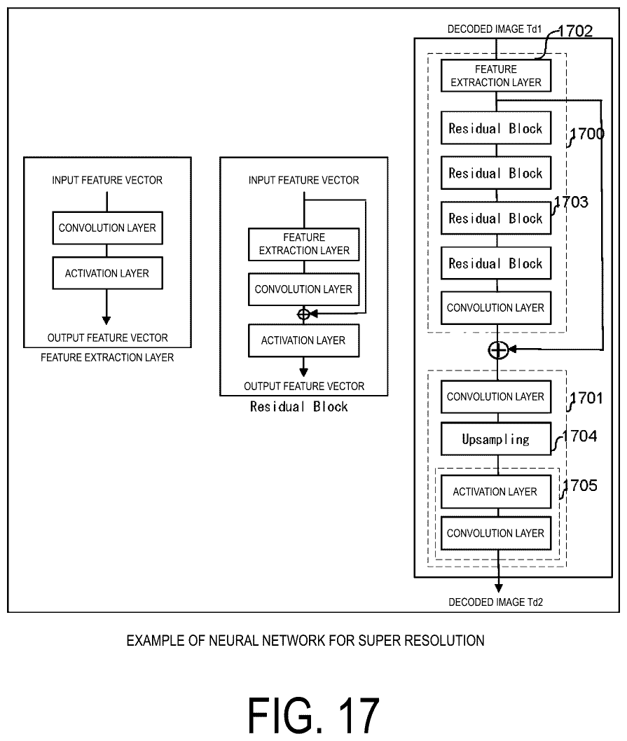

By using the syntax described above, the model parameter can be derived for each scaling ratio, allowing suitable image reconstruction processing to be performed. In a configuration using a neural network (1701) including a combination of first-half neural network processing (1700) with a factor of 1 and second-half UpSampling, as illustrated in FIG. 17, image reconstruction processing can be performed by using suitable model parameters for various scaling ratios. For example, the factor-of-1 portion of the first half portion 1700 uses the model parameter derived by model integration, and the second-half UpSampling uses the model parameter derived by using the scaling ratio. Thus, the model integration unit 612 can derive suitable model parameters for various scaling ratios without holding the second parameter BaseModel for each scaling ratio.

By weighting only a specific parameter among the model parameters, processing of the integrated pattern of the models is facilitated. A portion using a fixed parameter requires one BaseModel for processing, enabling a reduction in the number of model parameters for the BaseModel required to generate an integrated model.

For example, in a case that scale_factor is 1, the input and output image sizes are the same. Otherwise, processing is performed to obtain the size (number of channels)*(width*scale_factor)*(height*scale_factor). In a case that num_of_const_param is signaled, only a specific model parameter for BaseModel[i] is multiplied by weight_coeff[i] in (Equation Weight-1). The example of FIG. 16 indicates that the number of parameters required for model integration using weighting increases with decreasing value of num_of_const_param, leading to a higher degree of freedom. Conversely, the amount of parameters derived using weighting during model integration decreases with increasing value of num_of_const_param. Therefore, despite a reduced degree of freedom, the number of model parameters for the base model required for weighting may be reduced.

By performing the above-described processing, various output images can be generated, allowing the expression capability of the first model parameter to be enhanced, and allowing the implementation to be simplified.

### Post-Processing Unit 611

The post-processing unit 611 performs filter processing by a neural network using the first model parameter WeightedModel derived by the model integration unit 612. Here, the filter processing may be a loop filter applied to the reference image or a post filter applied to the output image.

In the loop filter configuration, the post-processing unit 611 is performed as one processing operation of the loop filter 305, the input is a locally decoded image, and the output is used as a reference image.

In the post-filter configuration, a decoded image Td1 and the WeightedModel are input to the post-processing unit 611, and an output Td2 is output to the outside (for example, the image display apparatus 41).

The filter of the post-processing unit 611 may be processing in which the size (width, height) of the input image is equal to the size (width, height) of the output image, that is, processing that does not include resolution conversion. Alternatively, the processing may include changing the width and the height, that is, performing resolution conversion.

The neural network is processing for receiving an image (tensor) of (channel: C)*(width: W)*(height: H) and outputting an image (tensor) of (number of channels: C)*(width: W*scale_factor)*(height: H*scale_factor). Here, scale_factor indicates a scaling ratio, and in a case that scale_factor is 1, a factor of 1 is used, and in a case that scale_factor is other than 1, resolution conversion is performed. In the configuration of the loop filter, scale_factor=1 is generally used, but the configuration is not limited to scale_factor=1. scale_factor may be transmitted as one syntax element of the coded data as illustrated in FIG. 15.

The channel C may include three channels including a luma component and two chroma components or RGB, or may be one channel of a luma component, a chroma component, or RGB. The channel C may include two chroma components. In a case that the luminance and the chrominance are different in size, such as 4:2:0, one luma component, four Cb components, and four Cr components may be allocated.

The neural network as used herein includes a layer (convolution layer, Conv) which performs a product-sum of an input vector and a weight, which is a parameter element of the neural network, and adds a bias, and a layer (activation layer, Act) which performs non-linear processing on a derived value. The activation layer may use Relu, leakyRelu, PRelu, ELU, or the like. Relu is processing for returning max (x, 0). leakyRelu is processing for applying a gradient of a*x in a case that in Relu, x<0. Each of PRelu and ELU is processing in which the gradient parameter of leakyRelu is used as an updatable parameter instead of a fixed value. The neural network is not limited to the above-described configuration ConvolutionNeuralNetoworl (CNN), and may include a Pooling layer or a layer referred to as FullConnection (FNN), Squeeze-and-Excitation Networks, SelfAttention, or attention. For resolution conversion (subsequent Upsampling), the neural network may include linear processing such as bilinear, bicubic, or lanczos, or processing referred to as depth2space, PixelShuffle, or Deconvolution (transposed convolution). The Pooling layer is a layer in which values are averaged or maximized on a per-unit basis. FNN is a layer that couples all inputs regardless of location. Each of Squeeze-and-Excitation Networks, SelfAttention, and transformer corresponds to attention for weighting channels. The neural network may additionally include linear processing such as sinc, hamming, hanning, DCT, DST, FFT, DWT (Wavelet), a high-pass filter, a low-pass filter, or a filter bank. The neural network may also include skip connection referred to as ResidualNetwork (ResNet), or processing for stacking multiple inputs in a channel. The neural network may also include processing (element sum) for adding values to multiple inputs without stacking, or processing for calculating an element-wise product corresponding to the product of multiple inputs.

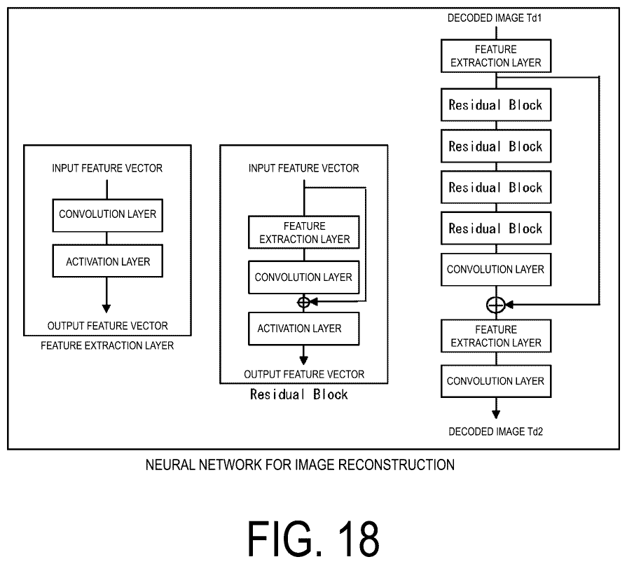

FIG. 18 illustrates an example of a neural network according to the present embodiment. FIG. 18 is used for processing in which the resolution is not converted.

FIG. 17 illustrates an example of a neural network according to the present embodiment. FIG. 17 is used for processing in which the resolution is converted. Here, the neural network includes a neural network (feature extraction structure) 1700 that performs factor-of-1 processing and a neural network 1701 that performs resolution conversion. The feature extraction structure 1700 includes multiple feature extraction layers 1702 and multiple Residual Blocks 1703. The feature extraction layer includes the convolution layer and the activation layer described above. The Residual Block includes a feature extraction layer, a Convolution layer, and an Activation layer. The neural network 1701 that performs resolution conversion includes a Convolution layer, an Upsampling unit 1704, and a feature extraction layer 1705. The present network incorporates a residual structure (Residual Block), which is a structure for enhancing the performance of the neural network. The residual structure is a structure for learning a difference between different feature vectors obtained from the neural network. In the example of the super-resolution neural network in FIG. 17, the residual structure is used in the Residual Block and feature extraction structure 1700. The UpSampling filter 1704 converts the width and height of a feature vector output from the feature extraction structure 1700 into the width and height of an output. The UpSampling filter may be bilinear, bicubic, PixelShuffle, deconvolution, or the like. Note that the scaling ratio for the UpSampling filter may be changed by using scale_factor. For example, in a case that PixelShuffler is used, after the number of channels is increased by a factor of scale_factor*scale_factor, the channel is multiplied by 1/(scale_factor*scale_factor) to multiply each of the height and width by a factor of scale_factor.

In a case that TransposedConvolution is used,

TransposedConvolutton(kernel=scale . . . factor,stride=scale . . . factor)

can be used for enlargement by a factor of scale_factor.

The feature extraction layer 1705 generates, from the enlarged feature vector, an output image having the same channel, width, and height as the input image.

BaseModel[i] and WeightedModel are model parameters for the neural network that performs the above-described post-filter processing and loop filter processing, and BaseModel[i] and WeightedModel have the same structure. BaseModel[i] is a prescribed model parameter, and WeightedModel is a model parameter obtained by weighting BaseModel[i].

As described above, the first model parameter is derived from the syntax of the present invention, and is subjected to inverse resolution conversion. This allows higher-quality videos to be generated than selection of any model parameter from the set of model parameters.

### Filter Information Signaling for Inverse Resolution Conversion

The post-processing apparatus 61 of the present embodiment can be used for pre-processing and post-processing including resolution conversion. Here, an example of such utilization will be described.

FIG. 1 is a block diagram in which a video generated by the pre-processing apparatus 51 is coded by the image coding apparatus 11, and a video decoded by the image decoding apparatus 31 is processed by the post-processing apparatus 61.

The video coding apparatus 10 inputs the input image T1 to the composite information creating apparatus 71 to create filter information for deriving the first model parameter. Then, the filter information is transmitted to the image coding apparatus 11. The composite information creating apparatus 71 creates filter information from statistical information regarding pixel values of the input image T1. The image coding apparatus 11 uses the pre-processing apparatus 51 to code the reduced image T2 obtained by reducing the resolution of the input image T1 and the filter information (referred to as a coded image). Then, the filter information and the coded image are transmitted to the network 21 as coded data Te.

In the video decoding apparatus 30, the image decoding apparatus 31 decodes the coded data Te including the coded image and the filter information, and sends the decoded coded data Te to the post-processing apparatus 61.

FIG. 12 is a block diagram illustrating a configuration of the post-processing apparatus 61. The post-processing apparatus 61 includes the post-processing unit 611 and the model integration unit 612, receives the decoded image Td1 and the filter information, and outputs the decoded image Td2. The model integration unit 612 derives the first model parameter from the input filter information, and sends the first model parameter to the post-processing unit 611. The first model parameter is derived by using a weighting coefficient obtained from the filter information to obtain a weighted sum of the second model parameters, and dividing the weighted sum by a value indicated by the filter information (or performing a shift operation). The post-processing unit 611 receives the decoded image Td1 and the first model parameter and outputs the decoded image Td2. Here, the post-processing unit 611 generates the decoded image Td2 by using the first model parameter to inversely convert the resolution of the decoded image Td1 to the same resolution as the input image, and outputs the decoded image Td2 to the image display apparatus 41.

The composite information creating apparatus 71 creates filter information using the input image T1 as an input and sends the filter information to the image coding apparatus 11. Here, the filter information includes a weighting coefficient created based on the input image T1, in other words, data necessary for deriving the first model parameter.

The image decoding apparatus 31 (header decoder 3020) decodes, based on the syntax of FIG. 13 or FIG. 15, the filter information from the coded data Te acquired via the network 21, and sends the decoding result to the post-processing apparatus 61.

The post-processing apparatus 61 derives the first model parameter by using the filter information to perform the processing illustrated in FIG. 14 or FIG. 16. Then, the post-processing apparatus 61 generates the decoded image Td2 by inversely converting the resolution of Td1 using the image Td1 decoded by the image decoding apparatus 31 and the first model parameter.

### Application Examples

The above-mentioned video coding apparatus 10 and video decoding apparatus 30 can be utilized by being installed in various apparatuses performing transmission, reception, recording, and reconstruction of videos. Note that, the video may be a natural video imaged by camera or the like, or may be an artificial video (including CG and GUI) generated by computer or the like.

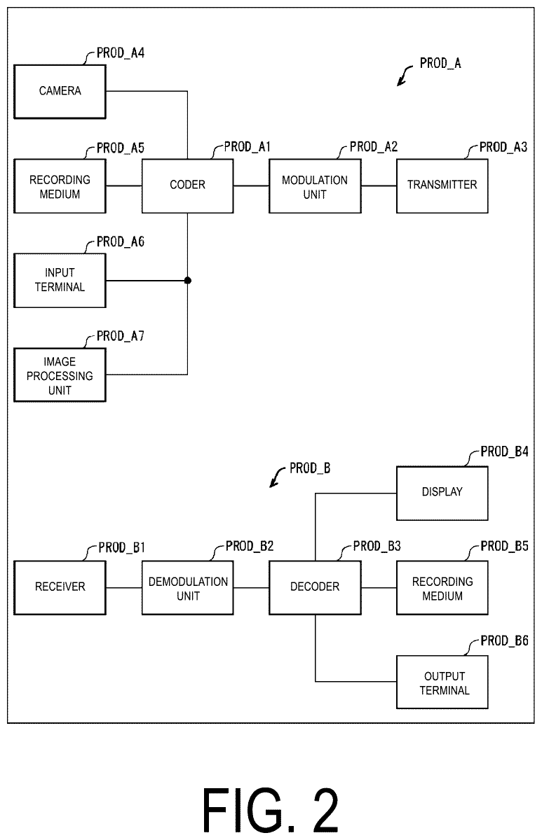

First, referring to FIG. 2, description will be given of the above-mentioned video coding apparatus 10 and video decoding apparatus 30, which can be utilized for transmission and reception of videos.

PROD_A in FIG. 2 is a block diagram illustrating a configuration of a transmission apparatus PROD_A equipped with the video coding apparatus 10. As illustrated in FIG. 2, the transmission apparatus PROD_A includes a coder PROD_A1 which obtains coded data by coding videos, a modulation unit PROD_A2 which obtains modulation signals by modulating carrier waves with the coded data obtained by the coder PROD_A1, and a transmitter PROD_A3 which transmits the modulation signals obtained by the modulation unit PROD_A2. The above-mentioned video coding apparatus 10 is utilized as the coder PROD_A1.

The transmission apparatus PROD_A may further include a camera PROD_A4 that images videos, a recording medium PROD_A5 that records videos, an input terminal PROD_A6 for inputting videos from the outside, and an image processing unit A7 which generates or processes images, as supply sources of videos to be input into the coder PROD_A1. Although an example configuration in which the transmission apparatus PROD_A includes all of the constituents is illustrated in the diagram, some of the constituents may be omitted.

Note that the recording medium PROD_A5 may record videos which are not coded or may record videos coded in a coding scheme for recording different from a coding scheme for transmission. In the latter case, a decoder (not illustrated) to decode coded data read from the recording medium PROD_A5 according to the coding scheme for recording may be present between the recording medium PROD_A5 and the coder PROD_A1.

PROD_B in FIG. 2 is a block diagram illustrating a configuration of a reception apparatus PROD_B equipped with the video decoding apparatus 30. As illustrated in the diagram, the reception apparatus PROD_B includes a receiver PROD_B1 that receives modulation signals, a demodulation unit PROD_B2 that obtains coded data by demodulating the modulation signals received by the receiver PROD_B1, and a decoder PROD_B3 that obtains videos by decoding the coded data obtained by the demodulation unit PROD_B2. The above-mentioned video decoding apparatus 30 is utilized as the decoder PROD_B3.

The reception apparatus PROD_B may further include a display PROD_B4 that displays videos, a recording medium PROD_B5 for recording the videos, and an output terminal PROD_B6 for outputting the videos to the outside, as supply destinations of the videos to be output by the decoder PROD_B3. Although an example configuration that the reception apparatus PROD_B includes all of the constituents is illustrated in the diagram, some of the constituents may be omitted.

Note that the recording medium PROD_B5 may record videos which are not coded, or may record videos which are coded in a coding scheme for recording different from a coding scheme for transmission. In the latter case, a coder (not illustrated) that codes videos acquired from the decoder PROD_B3 according to the coding scheme for recording may be present between the decoder PROD_B3 and the recording medium PROD_B5.

Note that a transmission medium for transmitting the modulation signals may be a wireless medium or may be a wired medium. A transmission mode in which the modulation signals are transmitted may be a broadcast (here, which indicates a transmission mode in which a transmission destination is not specified in advance) or may be a communication (here, which indicates a transmission mode in which a transmission destination is specified in advance). That is, the transmission of the modulation signals may be realized by any of a wireless broadcast, a wired broadcast, a wireless communication, and a wired communication.

For example, a broadcasting station (e.g., broadcasting equipment)/receiving station (e.g., television receiver) for digital terrestrial broadcasting is an example of the transmission apparatus PROD_A/reception apparatus PROD_B for transmitting and/or receiving the modulation signals in the wireless broadcast. A broadcasting station (e.g., broadcasting equipment)/receiving station (e.g., television receivers) for cable television broadcasting is an example of the transmission apparatus PROD_A/reception apparatus PROD_B for transmitting and/or receiving the modulation signals in the wired broadcast.

A server (e.g., workstation)/client (e.g., television receiver, personal computer, smartphone) for Video On Demand (VOD) services, video hosting services and the like using the Internet is an example of the transmission apparatus PROD_A/reception apparatus PROD_B for transmitting and/or receiving the modulation signals in communication (usually, any of a wireless medium or a wired medium is used as a transmission medium in LAN, and the wired medium is used as a transmission medium in WAN). Here, personal computers include a desktop PC, a laptop PC, and a tablet PC. Smartphones also include a multifunctional mobile telephone terminal.

Note that a client of a video hosting service has a function of coding a video imaged with a camera and uploading the video to a server, in addition to a function of decoding coded data downloaded from a server and displaying on a display. Thus, the client of the video hosting service functions as both the transmission apparatus PROD_A and the reception apparatus PROD_B.

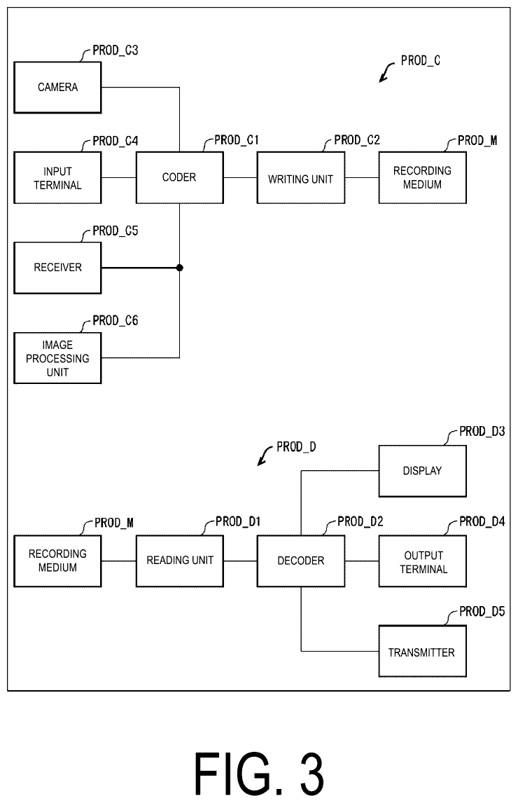

Next, referring to FIG. 3, description will be given of the above-mentioned video coding apparatus 10 and video decoding apparatus 30, which can be utilized for recording and reproduction of videos.

PROD_C in FIG. 3 is a block diagram illustrating a configuration of a recording apparatus PROD_C equipped with the above-mentioned video coding apparatus 10. As illustrated in FIG. 3, the recording apparatus PROD_C includes a coder PROD_C1 that obtains coded data by coding a video, and a writing unit PROD_C2 that writes the coded data obtained by the coder PROD_C1 in a recording medium PROD_M. The above-mentioned video coding apparatus 10 is utilized as the coder PROD_C1.

Note that the recording medium PROD_M may be (1) a type of recording medium built in the recording apparatus PROD_C such as Hard Disk Drive (HDD) or Solid State Drive (SSD), may be (2) a type of recording medium connected to the recording apparatus PROD_C such as an SD memory card or a Universal Serial Bus (USB) flash memory, and may be (3) a type of recording medium loaded in a drive apparatus (not illustrated) built in the recording apparatus PROD_C such as Digital Versatile Disc (DVD: trade name) or Blu-ray Disc (BD: trade name).

The recording apparatus PROD_C may further include a camera PROD_C3 that images a video, an input terminal PROD_C4 for inputting the video from the outside, a receiver PROD_C5 for receiving the video, and an image processing unit PROD_C6 that generates or processes images, as supply sources of the video input into the coder PROD_C1. Although an example configuration that the recording apparatus PROD_C includes all of the constituents is illustrated in the diagram, some of the constituents may be omitted.

Note that the receiver PROD_C5 may receive a video which is not coded, or may receive coded data coded in a coding scheme for transmission different from the coding scheme for recording. In the latter case, a decoder for transmission (not illustrated) that decodes coded data coded in the coding scheme for transmission may be present between the receiver PROD_C5 and the coder PROD_C1.

Examples of such recording apparatus PROD_C include, for example, a DVD recorder, a BD recorder, a Hard Disk Drive (HDD) recorder, and the like (in this case, the input terminal PROD_C4 or the receiver PROD_C5 is the main supply source of videos). A camcorder (in this case, the camera PROD_C3 is the main supply source of videos), a personal computer (in this case, the receiver PROD_C5 or the image processing unit C6 is the main supply source of videos), a smartphone (in this case, the camera PROD_C3 or the receiver PROD_C5 is the main supply source of videos), or the like is an example of the recording apparatus PROD_C as well.

FIG. 3 PROD-D is a block illustrating a configuration of a reconstruction apparatus PROD_D equipped with the above-mentioned video decoding apparatus 30. As illustrated in the diagram, the reconstruction apparatus PROD_D includes a reading unit PROD_D1 which reads coded data written in the recording medium PROD_M, and a decoder PROD_D2 which obtains a video by decoding the coded data read by the reading unit PROD_D1. The above-mentioned video decoding apparatus 30 is utilized as the decoder PROD_D2.

Note that the recording medium PROD_M may be (1) a type of recording medium built in the reconstruction apparatus PROD_D such as HDD or SSD, may be (2) a type of recording medium connected to the reconstruction apparatus PROD_D such as an SD memory card or a USB flash memory, and may be (3) a type of recording medium loaded in a drive apparatus (not illustrated) built in the reconstruction apparatus PROD_D such as a DVD or a BD.

The reconstruction apparatus PROD_D may further include a display PROD_D3 that displays a video, an output terminal PROD_D4 for outputting the video to the outside, and a transmitter PROD_D5 that transmits the video, as the supply destinations of the video to be output by the decoder PROD_D2. Although an example configuration that the reconstruction apparatus PROD_D includes all of the constituents is illustrated in the diagram, some of the constituents may be omitted.

Note that the transmitter PROD_D5 may transmit a video which is not coded or may transmit coded data coded in the coding scheme for transmission different from a coding scheme for recording. In the latter case, a coder (not illustrated) that codes a video in the coding scheme for transmission may be present between the decoder PROD_D2 and the transmitter PROD_D5.

Examples of the reconstruction apparatus PROD_D include, for example, a DVD player, a BD player, an HDD player, and the like (in this case, the output terminal PROD_D4 to which a television receiver, and the like are connected is the main supply destination of videos). A television receiver (in this case, the display PROD_D3 is the main supply destination of videos), a digital signage (also referred to as an electronic signboard or an electronic bulletin board, and the like, and the display PROD_D3 or the transmitter PROD_D5 is the main supply destination of videos), a desktop PC (in this case, the output terminal PROD_D4 or the transmitter PROD_D5 is the main supply destination of videos), a laptop or tablet PC (in this case, the display PROD_D3 or the transmitter PROD_D5 is the main supply destination of videos), a smartphone (in this case, the display PROD_D3 or the transmitter PROD_D5 is the main supply destination of videos), or the like is an example of the reconstruction apparatus PROD_D.

### Realization by Hardware and Realization by Software

Each block of the above-mentioned video decoding apparatus 30 and video coding apparatus 10 may be realized as a hardware by a logical circuit formed on an integrated circuit (IC chip), or may be realized as a software using a Central Processing Unit (CPU).

In the latter case, each of the above-described apparatuses includes a CPU that performs a command of a program to implement each of functions, a Read Only Memory (ROM) that stores the program, a Random Access Memory (RAM) to which the program is loaded, and a storage apparatus (recording medium), such as a memory, that stores the program and various kinds of data. In addition, an objective of the embodiment of the present invention can be achieved by supplying, to each of the apparatuses, the recording medium that records, in a computer readable form, program codes of a control program (executable program, intermediate code program, source program) of each of the apparatuses that is software for realizing the above-described functions and by reading and performing, by the computer (or a CPU or an MPU), the program codes recorded in the recording medium.

As the recording medium, for example, tapes including a magnetic tape, a cassette tape and the like, discs including a magnetic disc such as a floppy (trade name) disk/a hard disk and an optical disc such as a Compact Disc Read-Only Memory (CD-ROM)/Magneto-Optical disc (MO disc)/Mini Disc (MD)/Digital Versatile Disc (DVD: trade name)/CD Recordable (CD-R)/Blu-ray Disc (trade name), cards such as an IC card (including a memory card)/an optical card, semiconductor memories such as a mask ROM/Erasable Programmable Read-Only Memory (EPROM)/Electrically Erasable and Programmable Read-Only Memory (EEPROM: trade name)/a flash ROM, logical circuits such as a Programmable logic device (PLD) and a Field Programmable Gate Array (FPGA), or the like can be used.

Each of the apparatuses may be configured to be connectable to a communication network, and the program codes may be supplied through the communication network. The communication network may be any network as long as the network is capable of transmitting the program codes, and is not limited to a particular communication network. For example, the Internet, an intranet, an extranet, a Local Area Network (LAN), an Integrated Services Digital Network (ISDN), a Value-Added Network (VAN), a Community Antenna television/Cable Television (CATV) communication network, a Virtual Private Network, a telephone network, a mobile communication network, a satellite communication network, and the like are available. In addition, a transmission medium constituting this communication network may be any medium as long as the medium can transmit a program code, and is not limited to a particular configuration or type of transmission medium. For example, a wired transmission medium such as Institute of Electrical and Electronic Engineers (IEEE) 1394, a USB, a power line carrier, a cable TV line, a telephone line, an Asymmetric Digital Subscriber Line (ADSL) line, and a wireless transmission medium such as infrared ray of Infrared Data Association (IrDA) or a remote control, BlueTooth (trade name), IEEE 802.11 wireless communication, High Data Rate (HDR), Near Field Communication (NFC), Digital Living Network Alliance (DLNA: trade name), a cellular telephone network, a satellite channel, a terrestrial digital broadcast network are available. Note that the embodiment of the present invention can be also realized in the form of computer data signals embedded in a carrier wave such that the transmission of the program codes is embodied in electronic transmission.

The embodiment of the present invention is not limited to the above-described embodiment, and various modifications are possible within the scope of the claims. That is, an embodiment obtained by combining technical means modified appropriately within the scope of the claims is also included in the technical scope of the present invention.

### INDUSTRIAL APPLICABILITY

The embodiment of the present invention can be preferably applied to a video decoding apparatus that decodes coded data in which image data is coded, and a video coding apparatus that generates coded data in which image data is coded. The embodiment of the present invention can be preferably applied to a data structure of coded data generated by the video coding apparatus and referred to by the video decoding apparatus.

### REFERENCE SIGNS LIST

1 Video transmission system
30 Video decoding apparatus
31 Image decoding apparatus
301 Entropy decoder
302 Parameter decoder
303 Inter prediction parameter derivation unit
304 Intra prediction parameter derivation unit
305, 107 Loop filter
306, 109 Reference picture memory
307, 108 Prediction parameter memory
308, 101 Prediction image generation unit
309 Inter prediction image generation unit
310 Intra prediction image generation unit
311, 105 Inverse quantization and inverse transform processing unit
312, 106 Addition unit
320 Prediction parameter derivation unit
10 Video coding apparatus
11 Image coding apparatus
102 Subtraction unit
103 Transform and quantization unit
104 Entropy coder
110 Coding parameter determination unit
111 Parameter coder
112 Inter prediction parameter coder
113 Intra prediction parameter coder
120 Prediction parameter derivation unit
71 Filter information creating apparatus

1. An image decoding apparatus comprising:
a header decoder configured to decode filter information for deriving a first model parameter;
a model integration unit configured to derive a model parameter (the first model parameter) for a neural network from the filter information decoded; and
a post-processing unit configured to perform loop filter processing or post-processing by using the model parameter derived, wherein
the model integration unit derives the first model parameter from multiple weighting coefficients and a model parameter (a second model parameter) for the neural network.

2. The image decoding apparatus according to claim 1, wherein
the model integration unit derives the first model parameter from a weighted average of the weighting coefficients and the second model parameter.

3. The image decoding apparatus according to claim 1, wherein
the header decoder decodes a flag for indicating non-zero, decodes a weighting coefficient of the multiple weighting coefficients by decoding a magnitude of the weighting coefficient in a case that the flag indicates non-zero, and derives the weighting coefficient as zero in a case that the flag indicates zero.

4. The image decoding apparatus according to claim 1, wherein
the header decoder decodes a weighting coefficient of the multiple weighting coefficients having a negative value.

5. The image decoding apparatus according to claim 1, wherein
The header decoder decodes a scale factor indicating a ratio between an input image size and an output image size for the neural network.

6. The image decoding apparatus according to claim 5, wherein
the model integration unit derives the first model parameter by using the second model parameter that is different depending on the scale factor.

7. The image decoding apparatus according to claim 5, wherein
in a case that the scale factor indicates a value other than one, the post-processing unit performs post-processing by using the neural network partly including neural network processing for changing a size of an image.

8. The image decoding apparatus according to claim 1, wherein
the header decoder decodes information indicating the number of unweighted parameters among the first model parameters used in the post-processing.

9. A video coding apparatus comprising:
a pre-processing apparatus configured to perform processing including resolution conversion on an input image signal;
a filter information creating apparatus configured to create filter information necessary for deriving a first model parameter from the input image signal; and
an image coding apparatus configured to code an image processed by the pre-processing apparatus and the filter information created by the filter information creating apparatus.
